(19) United States
(12) Patent Application Publication
(10) Pub. No.: US 2020/0257404 A1
(43) Pub. Date: Aug. 13, 2020

(54) TOUCH SCREEN WITH MULTI-WAY TOUCH SENSING

(71) Applicant: SIGMASENSE, LLC., Wilmington, DE (US)

(72) Inventors: Daniel Keith Van Ostrand, Austin, TX (US); Michael Shawn Gray, Cedar Park, TX (US)

(73) Assignee: SIGMASENSE, LLC., Wilmington, DE (US)

(21) Appl. No.: 16/274,006

(22) Filed: Feb. 12, 2019

(51) Int. Cl. G06F 3/041; G06F 3/044

(52) U.S. Cl. CPC G06F 3/0418; G06F 2203/04104; G06F 3/0412; G06F 3/044

(57) ABSTRACT

A touch screen sensor includes a drive-sense module, first, second, and third sets of conductive pads. The first set of conductive pads is coupled to form rows. The second set of conductive pads is coupled to form columns that are electrically isolated from the rows. The third set of conductive pads is coupled zones, which are electrically isolated from the rows and from the columns. The drive-sense circuit is operable to drive signals on to the rows, the columns, and the zones. The drive-sense module is further operable to sense an electrical characteristic of the row, the columns, and the zones based on the signals. The drive-sense module is further operable to determine one or more touches on the touch screen sensor based on the sensed electrical characteristic.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to data communication systems and more particularly to sensed data collection and/or communication.

### Description of Related Art

Sensors are used in a wide variety of applications ranging from in-home automation, to industrial systems, to health care, to transportation, and so on. For example, sensors are placed in bodies, automobiles, airplanes, boats, ships, trucks, motorcycles, cell phones, televisions, touch-screens, industrial plants, appliances, motors, checkout counters, etc. for the variety of applications.

In general, a sensor converts a physical quantity into an electrical or optical signal. For example, a sensor converts a physical phenomenon, such as a biological condition, a chemical condition, an electric condition, an electromagnetic condition, a temperature, a magnetic condition, mechanical motion (position, velocity, acceleration, force, pressure), an optical condition, and/or a radioactivity condition, into an electrical signal.

A sensor includes a transducer, which functions to convert one form of energy (e.g., force) into another form of energy (e.g., electrical signal). There are a variety of transducers to support the various applications of sensors. For example, a transducer is capacitor, a piezoelectric transducer, a piezoresistive transducer, a thermal transducer, a thermal-couple, a photoconductive transducer such as a photoresistor, a photodiode, and/or phototransistor.

A sensor circuit is coupled to a sensor to provide the sensor with power and to receive the signal representing the physical phenomenon from the sensor. The sensor circuit includes at least three electrical connections to the sensor: one for a power supply; another for a common voltage reference (e.g., ground); and a third for receiving the signal representing the physical phenomenon. The signal representing the physical phenomenon will vary from the power supply voltage to ground as the physical phenomenon changes from one extreme to another (for the range of sensing the physical phenomenon).

The sensor circuits provide the received sensor signals to one or more computing devices for processing. A computing device is known to communicate data, process data, and/or store data. The computing device may be a cellular phone, a laptop, a tablet, a personal computer (PC), a work station, a video game device, a server, and/or a data center that support millions of web searches, stock trades, or on-line purchases every hour.

The computing device processes the sensor signals for a variety of applications. For example, the computing device processes sensor signals to determine temperatures of a variety of items in a refrigerated truck during transit. As another example, the computing device processes the sensor signals to determine a touch on a touch screen. As yet another example, the computing device processes the sensor signals to determine various data points in a production line of a product.

### BRIEF DESCRIPTION OF THE SEVERAL VIEWS OF THE DRAWING(S)

FIG. 1 is a schematic block diagram of an embodiment of a communication system in accordance with the present invention;

FIG. 2 is a schematic block diagram of an embodiment of a computing device in accordance with the present invention;

FIG. 3 is a schematic block diagram of another embodiment of a computing device in accordance with the present invention;

FIG. 4 is a schematic block diagram of an embodiment of a touch screen display in accordance with the present invention;

FIG. 5 is a schematic block diagram of another embodiment of a touch screen display in accordance with the present invention;

FIG. 6 is a logic diagram of an embodiment of a method for sensing a touch on a touch screen display in accordance with the present invention;

FIG. 7 is a schematic block diagram of an embodiment of a drive sense circuit in accordance with the present invention;

FIG. 8 is a schematic block diagram of another embodiment of a drive sense circuit in accordance with the present invention;

FIG. 9 is a schematic block diagram of an example of drive sense circuits coupled to electrodes without a touch proximal to the electrodes in accordance with the present invention;

FIG. 10 is a schematic block diagram of an example of drive sense circuits coupled electrodes with a finger touch proximal to the electrodes in accordance with the present invention;

FIG. 11 is an example graph that plots condition verses capacitance for an electrode of a touch screen display in accordance with the present invention;

FIG. 12 is an example graph that plots impedance verses frequency for an electrode of a touch screen display in accordance with the present invention;

FIG. 13 is a time domain example graph that plots magnitude verses time for an analog reference signal in accordance with the present invention;

FIG. 14 is a frequency domain example graph that plots magnitude verses frequency for an analog reference signal in accordance with the present invention;

FIG. 15 is a cross section schematic block diagram of an example of a touch screen display with in-cell touch sensors in accordance with the present invention;

FIG. 16 is a schematic block diagram of an example of a transparent electrode layer with thin film transistors in accordance with the present invention;

FIG. 17 is a schematic block diagram of an example of a pixel with three sub-pixels in accordance with the present invention;

FIG. 18 is a schematic block diagram of an example of sub-pixel electrodes coupled together to form conductive pads of a touch screen sensor in accordance with the present invention;

FIG. 19 is a schematic block diagram of an example of conductive pads of a touch screen sensor coupled together to form rows, columns, and zones in accordance with the present invention;

FIG. 20 is a schematic block diagram of another example of conductive pads of a touch screen sensor coupled together to form rows, columns, and zones in accordance with the present invention;

FIG. 21 is a schematic block diagram of another example of conductive pads of a touch screen sensor coupled together to form rows, columns, and zones in accordance with the present invention;

FIG. 22 is a schematic block diagram of an example of a pattern of conductive pads forming three-way touch sense cells in accordance with the present invention;

FIG. 23 is a schematic block diagram of another example of a pattern of conductive pads forming three-way touch sense cells in accordance with the present invention;

FIG. 24 is a schematic block diagram of an example of conductive pads forming rows in accordance with the present invention;

FIG. 25 is a schematic block diagram of an example of conductive pads forming columns in accordance with the present invention;

FIG. 26 is a schematic block diagram of an example of conductive pads forming zones in accordance with the present invention;

FIG. 27 is a schematic block diagram of an example of touches activating rows and columns in accordance with the present invention;

FIG. 28 is a schematic block diagram of an example of touches activating zone rows and zone columns in accordance with the present invention;

FIG. 29 is a schematic block diagram of another example of a pattern of conductive pads forming three-way touch sense cells in accordance with the present invention; and

FIG. 30 is a schematic block diagram of another example of a pattern of conductive pads forming three-way touch sense cells in accordance with the present invention.

### DETAILED DESCRIPTION OF THE INVENTION

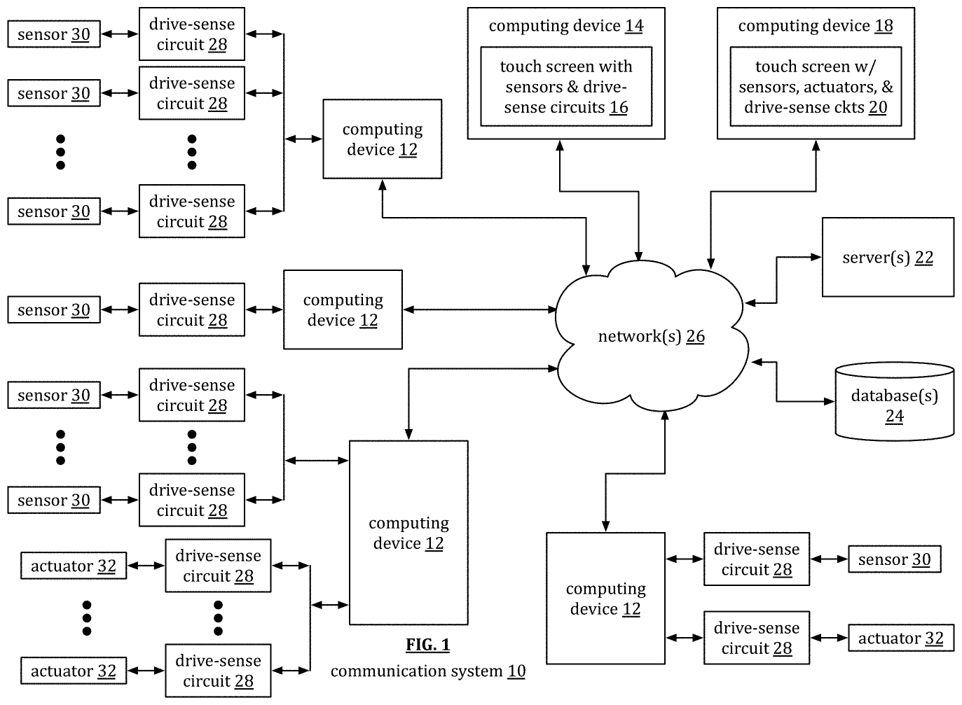

FIG. 1 is a schematic block diagram of an embodiment of a communication system 10 that includes a plurality of computing. devices 12-10, one or more servers 22, one or more databases 24, one or more networks 26, a plurality of drive-sense circuits 28, a plurality of sensors 30, and a plurality of actuators 32. Computing devices 14 include a touch screen 16 with sensors and drive-sensor circuits and computing devices 18 include a touch & tactic screen 20 that includes sensors, actuators, and drive-sense circuits.

A sensor 30 functions to convert a physical input into an electrical output and/or an optical output. The physical input of a sensor may be one of a variety of physical input conditions. For example, the physical condition includes one or more of, but is not limited to, acoustic waves (e.g., amplitude, phase, polarization, spectrum, and/or wave velocity); a biological and/or chemical condition (e.g., fluid concentration, level, composition, etc.); an electric condition (e.g., charge, voltage, current, conductivity, permittivity, eclectic field, which includes amplitude, phase, and/or polarization); a magnetic condition (e.g., flux, permeability, magnetic field, which amplitude, phase, and/or polarization); an optical condition (e.g., refractive index, reflectivity, absorption, etc.); a thermal condition (e.g., temperature, flux, specific heat, thermal conductivity, etc.); and a mechanical condition (e.g., position, velocity, acceleration, force, strain, stress, pressure, torque, etc.). For example, piezoelectric sensor converts force or pressure into an eclectic signal. As another example, a microphone converts audible acoustic waves into electrical signals.

There are a variety of types of sensors to sense the various types of physical conditions. Sensor types include, but are not limited to, capacitor sensors, inductive sensors, accelerometers, piezoelectric sensors, light sensors, magnetic field sensors, ultrasonic sensors, temperature sensors, infrared (IR) sensors, touch sensors, proximity sensors, pressure sensors, level sensors, smoke sensors, and gas sensors. In many ways, sensors function as the interface between the physical world and the digital world by converting real world conditions into digital signals that are then processed by computing devices for a vast number of applications including, but not limited to, medical applications, production automation applications, home environment control, public safety, and so on.

The various types of sensors have a variety of sensor characteristics that are factors in providing power to the sensors, receiving signals from the sensors, and/or interpreting the signals from the sensors. The sensor characteristics include resistance, reactance, power requirements, sensitivity, range, stability, repeatability, linearity, error, response time, and/or frequency response. For example, the resistance, reactance, and/or power requirements are factors in determining drive circuit requirements. As another example, sensitivity, stability, and/or linear are factors for interpreting the measure of the physical condition based on the received electrical and/or optical signal (e.g., measure of temperature, pressure, etc.).

An actuator 32 converts an electrical input into a physical output. The physical output of an actuator may be one of a variety of physical output conditions. For example, the physical output condition includes one or more of, but is not limited to, acoustic waves (e.g., amplitude, phase, polarization, spectrum, and/or wave velocity); a magnetic condition (e.g., flux, permeability, magnetic field, which amplitude, phase, and/or polarization); a thermal condition (e.g., temperature, flux, specific heat, thermal conductivity, etc.); and a mechanical condition (e.g., position, velocity, acceleration, force, strain, stress, pressure, torque, etc.). As an example, a piezoelectric actuator converts voltage into force or pressure. As another example, a speaker converts electrical signals into audible acoustic waves.

An actuator 32 may be one of a variety of actuators. For example, an actuator 32 is one of a comb drive, a digital micro-mirror device, an electric motor, an electroactive polymer, a hydraulic cylinder, a piezoelectric actuator, a pneumatic actuator, a screw jack, a servomechanism, a solenoid, a stepper motor, a shape-memory allow, a thermal bimorph, and a hydraulic actuator.

The various types of actuators have a variety of actuators characteristics that are factors in providing power to the actuator and sending signals to the actuators for desired performance. The actuator characteristics include resistance, reactance, power requirements, sensitivity, range, stability, repeatability, linearity, error, response time, and/or frequency response. For example, the resistance, reactance, and power requirements are factors in determining drive circuit requirements. As another example, sensitivity, stability, and/or linear are factors for generating the signaling to send to the actuator to obtain the desired physical output condition.

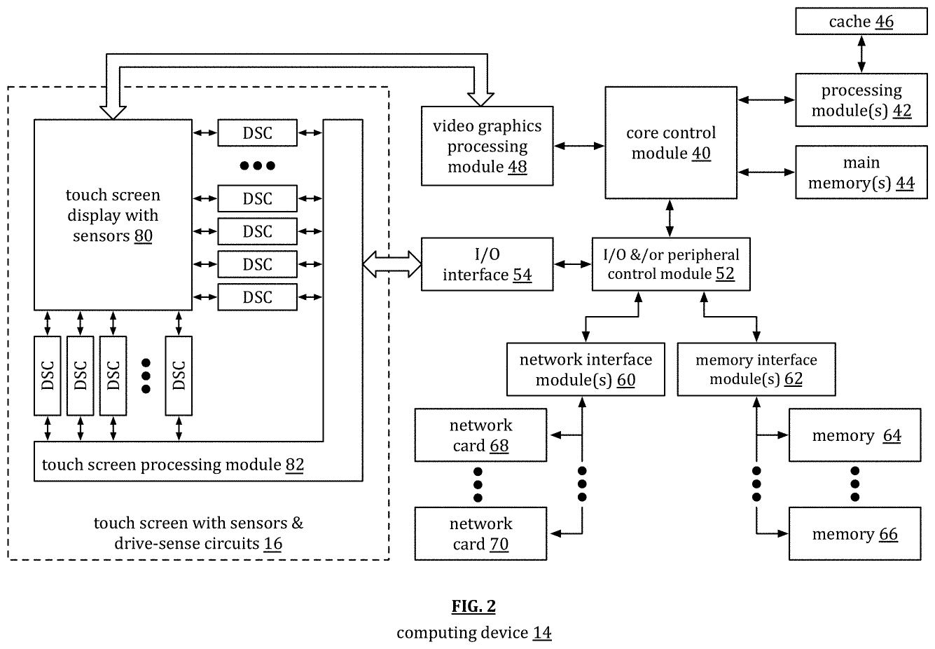

The computing devices 12, 14, and 18 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. The computing devices 12, 14, and 18 will be discussed in greater detail with reference to one or more of FIGS. 2-4.

A server 22 is a special type of computing device that is optimized for processing large amounts of data requests in parallel. A server 22 includes similar components to that of the computing devices 12, 14, and/or 18 with more robust processing modules, more main memory, and/or more hard drive memory (e.g., solid state, hard drives, etc.). Further, a server 22 is typically accessed remotely; as such it does not generally include user input devices and/or user output devices. In addition, a server may be a standalone separate computing device and/or may be a cloud computing device.

A database 24 is a special type of computing device that is optimized for large scale data storage and retrieval. A database 24 includes similar components to that of the computing devices 12, 14, and/or 18 with more hard drive memory (e.g., solid state, hard drives, etc.) and potentially with more processing modules and/or main memory. Further, a database 24 is typically accessed remotely; as such it does not generally include user input devices and/or user output devices. In addition, a database 24 may be a standalone separate computing device and/or may be a cloud computing device.

The network 26 includes one more local area networks (LAN) and/or one or more wide area networks WAN), which may be a public network and/or a private network. A LAN may be a wireless-LAN (e.g., Wi-Fi access point, Bluetooth, ZigBee, etc.) and/or a wired network (e.g., Firewire, Ethernet, etc.). A WAN may be a wired and/or wireless WAN. For example, a LAN may be a personal home or business's wireless network and a WAN is the Internet, cellular telephone infrastructure, and/or satellite communication infrastructure.

In an example of operation, computing device 12-1 communicates with a plurality of drive-sense circuits 28, which, in turn, communicate with a plurality of sensors 30. The sensors 30 and/or the drive-sense circuits 28 are within the computing device 12-1 and/or external to it. For example, the sensors 30 may be external to the computing device 12-1 and the drive-sense circuits are within the computing device 12-1. As another example, both the sensors 30 and the drive-sense circuits 28 are external to the computing device 12-1. When the drive-sense circuits 28 are external to the computing device, they are coupled to the computing device 12-1 via wired and/or wireless communication links.

The computing device 12-1 communicates with the drive-sense circuits 28 to; (a) turn them on, (b) obtain data from the sensors (individually and/or collectively), (c) instruct the drive sense circuit on how to communicate the sensed data to the computing device 12-1, (d) provide signaling attributes (e.g., DC level, AC level, frequency, power level, regulated current signal, regulated voltage signal, regulation of an impedance, frequency patterns for various sensors, different frequencies for different sensing applications, etc.) to use with the sensors, and/or (e) provide other commands and/or instructions.

As a specific example, the sensors 30 are distributed along a pipeline to measure flow rate and/or pressure within a section of the pipeline. The drive-sense circuits 28 have their own power source (e.g., battery, power supply, etc.) and are proximally located to their respective sensors 30. At desired time intervals (milliseconds, seconds, minutes, hours, etc.), the drive-sense circuits 28 provide a regulated source signal or a power signal to the sensors 30. An electrical characteristic of the sensor 30 affects the regulated source signal or power signal, which is reflective of the condition (e.g., the flow rate and/or the pressure) that sensor is sensing.

The drive-sense circuits 28 detect the effects on the regulated source signal or power signals as a result of the electrical characteristics of the sensors. The drive-sense circuits 28 then generate signals representative of change to the regulated source signal or power signal based on the detected effects on the power signals. The changes to the regulated source signals or power signals are representative of the conditions being sensed by the sensors 30.

The drive-sense circuits 28 provide the representative signals of the conditions to the computing device 12-1. A representative signal may be an analog signal or a digital signal. In either case, the computing device 12-1 interprets the representative signals to determine the pressure and/or flow rate at each sensor location along the pipeline. The computing device may then provide this information to the server 22, the database 24, and/or to another computing device for storing and/or further processing.

As another example of operation, computing device 12-2 is coupled to a drive-sense circuit 28, which is, in turn, coupled to a senor 30. The sensor 30 and/or the drive-sense circuit 28 may be internal and/or external to the computing device 12-2. In this example, the sensor 30 is sensing a condition that is particular to the computing device 12-2. For example, the sensor 30 may be a temperature sensor, an ambient light sensor, an ambient noise sensor, etc. As described above, when instructed by the computing device 12-2 (which may be a default setting for continuous sensing or at regular intervals), the drive-sense circuit 28 provides the regulated source signal or power signal to the sensor 30 and detects an effect to the regulated source signal or power signal based on an electrical characteristic of the sensor. The drive-sense circuit generates a representative signal of the affect and sends it to the computing device 12-2.

In another example of operation, computing device 12-3 is coupled to a plurality of drive-sense circuits 28 that are coupled to a plurality of sensors 30 and is coupled to a plurality of drive-sense circuits 28 that are coupled to a plurality of actuators 32. The generally functionality of the drive-sense circuits 28 coupled to the sensors 30 in accordance with the above description.

Since an actuator 32 is essentially an inverse of a sensor in that an actuator converts an electrical signal into a physical condition, while a sensor converts a physical condition into an electrical signal, the drive-sense circuits 28 can be used to power actuators 32. Thus, in this example, the computing device 12-3 provides actuation signals to the drive-sense circuits 28 for the actuators 32. The drive-sense circuits modulate the actuation signals on to power signals or regulated control signals, which are provided to the actuators 32. The actuators 32 are powered from the power signals or regulated control signals and produce the desired physical condition from the modulated actuation signals.

As another example of operation, computing device 12-x is coupled to a drive-sense circuit 28 that is coupled to a sensor 30 and is coupled to a drive-sense circuit 28 that is coupled to an actuator 32. In this example, the sensor 30 and the actuator 32 are for use by the computing device 12-x. For example, the sensor 30 may be a piezoelectric microphone and the actuator 32 may be a piezoelectric speaker.

FIG. 2 is a schematic block diagram of an embodiment of a computing device 12 (e.g., any one of 12-1 through 12-x). The computing device 12 includes a touch screen 16, a core control module 40, one or more processing modules 42, one or more main memories 44, cache memory 46, a video graphics processing module 48, a display 50, an Input-Output (I/O) peripheral control module 52, one or more input interface modules 56, one or more output interface modules 58, one or more network interface modules 60, and one or more memory interface modules 62. A processing module 42 is described in greater detail at the end of the detailed description of the invention section and, in an alternative embodiment, has a direction connection to the main memory 44. In an alternate embodiment, the core control module 40 and the I/O and/or peripheral control module 52 are one module, such as a chipset, a quick path interconnect (QPI), and/or an ultra-path interconnect (UPI).

The touch screen 16 includes a touch screen display 80, a plurality of sensors 30, a plurality of drive-sense circuits (DSC), and a touch screen processing module 82. In general, the sensors (e.g., electrodes, capacitor sensing cells, capacitor sensors, inductive sensor, etc.) detect a proximal touch of the screen. For example, when one or more fingers touches the screen, capacitance of sensors proximal to the touch(es) are affected (e.g., impedance changes). The drive-sense circuits (DSC) coupled to the affected sensors detect the change and provide a representation of the change to the touch screen processing module 82, which may be a separate processing module or integrated into the processing module 42.

The touch screen processing module 82 processes the representative signals from the drive-sense circuits (DSC) to determine the location of the touch(es). This information is inputted to the processing module 42 for processing as an input. For example, a touch represents a selection of a button on screen, a scroll function, a zoom in-out function, etc. The combination of the touch screen processing module 82 and the drive sense circuits (DSC) form an embodiment of a drive sense module.

Each of the main memories 44 includes one or more Random Access Memory (RAM) integrated circuits, or chips. For example, a main memory 44 includes four DDR4 (4^{th} generation of double data rate) RAM chips, each running at a rate of 2,400 MHz. In general, the main memory 44 stores data and operational instructions most relevant for the processing module 42. For example, the core control module 40 coordinates the transfer of data and/or operational instructions from the main memory 44 and the memory 64-66. The data and/or operational instructions retrieve from memory 64-66 are the data and/or operational instructions requested by the processing module or will most likely be needed by the processing module. When the processing module is done with the data and/or operational instructions in main memory, the core control module 40 coordinates sending updated data to the memory 64-66 for storage.

The memory 64-66 includes one or more hard drives, one or more solid state memory chips, and/or one or more other large capacity storage devices that, in comparison to cache memory and main memory devices, is/are relatively inexpensive with respect to cost per amount of data stored. The memory 64-66 is coupled to the core control module 40 via the I/O and/or peripheral control module 52 and via one or more memory interface modules 62. In an embodiment, the I/O and/or peripheral control module 52 includes one or more Peripheral Component Interface (PCI) buses to which peripheral components connect to the core control module 40. A memory interface module 62 includes a software driver and a hardware connector for coupling a memory device to the I/O and/or peripheral control module 52. For example, a memory interface 62 is in accordance with a Serial Advanced Technology Attachment (SATA) port.

The core control module 40 coordinates data communications between the processing module(s) 42 and the network(s) 26 via the I/O and/or peripheral control module 52, the network interface module(s) 60, and a network card 68 or 70. A network card 68 or 70 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 60 includes a software driver and a hardware connector for coupling the network card to the I/O and/or peripheral control module 52. For example, the network interface module 60 is in accordance with one or more versions of IEEE 802.11, cellular telephone protocols, 10/100/1000 Gigabit LAN protocols, etc.

The core control module 40 coordinates data communications between the processing module(s) 42 and input device(s) 72 via the input interface module(s) 56 and the I/O and/or peripheral control module 52. An input device 72 includes a keypad, a keyboard, control switches, a touchpad, a microphone, a camera, etc. An input interface module 56 includes a software driver and a hardware connector for coupling an input device to the I/O and/or peripheral control module 52. In an embodiment, an input interface module 56 is in accordance with one or more Universal Serial Bus (USB) protocols.

The core control module 40 coordinates data communications between the processing module(s) 42 and output device(s) 74 via the output interface module(s) 58 and the I/O and/or peripheral control module 52. An output device 74 includes a speaker, etc. An output interface module 58 includes a software driver and a hardware connector for coupling an output device to the I/O and/or peripheral control module 52. In an embodiment, an output interface module 56 is in accordance with one or more audio codec protocols.

The processing module 42 communicates directly with a video graphics processing module 48 to display data on the display 50. The display 50 includes an LED (light emitting diode) display, an LCD (liquid crystal display), and/or other type of display technology. The display has a resolution, an aspect ratio, and other features that affect the quality of the display. The video graphics processing module 48 receives data from the processing module 42, processes the data to produce rendered data in accordance with the characteristics of the display, and provides the rendered data to the display 50.

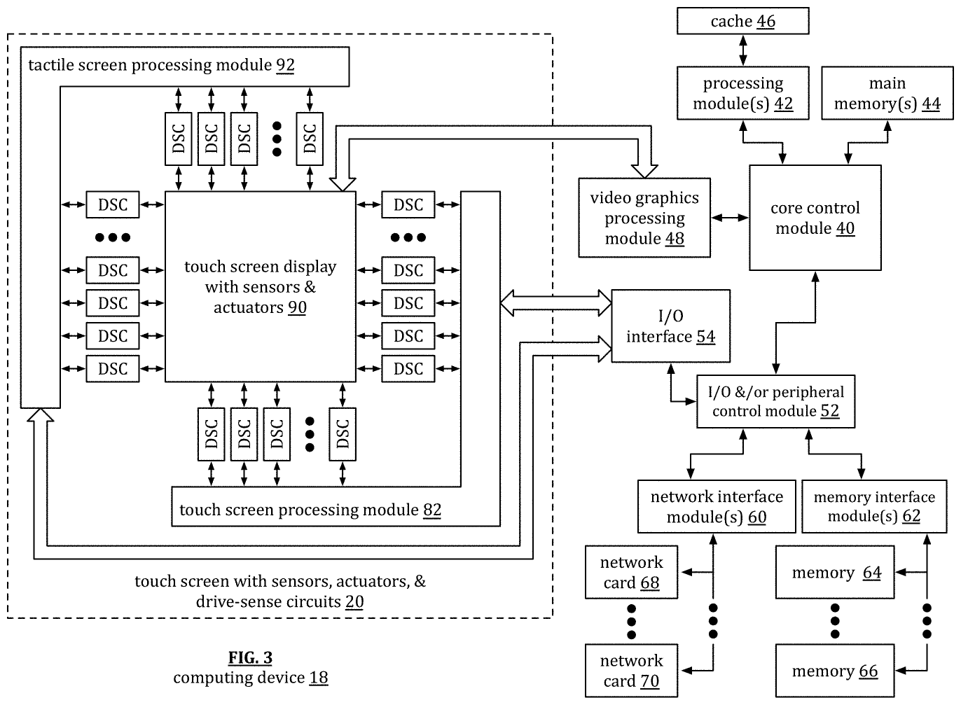

FIG. 3 is a schematic block diagram of another embodiment of a computing device 18 that includes a core control module 40, one or more processing modules 42, one or more main memories 44, cache memory 46, a video graphics processing module 48, a touch and tactile screen 20, an Input-Output (I/O) peripheral control module 52, one or more input interface modules 56, one or more output interface modules 58, one or more network interface modules 60, and one or more memory interface modules 62. The touch and tactile screen 20 includes a touch and tactile screen display 90, a plurality of sensors 30, a plurality of actuators 32, a plurality of drive-sense circuits (DSC), a touch screen processing module 82, and a tactile screen processing module 92.

Computing device 18 operates similarly to computing device 14 of FIG. 2 with the addition of a tactile aspect to the screen 20 as an output device. The tactile portion of the screen 20 includes the plurality of actuators (e.g., piezoelectric transducers to create vibrations, solenoids to create movement, etc.) to provide a tactile feel to the screen 20. To do so, the processing module creates tactile data, which is provided to the appropriate drive-sense circuits (DSC) via the tactile screen processing module 92, which may be a stand-alone processing module or integrated into processing module 42. The drive-sense circuits (DSC) convert the tactile data into drive-actuate signals and provide them to the appropriate actuators to create the desired tactile feel on the screen 20.

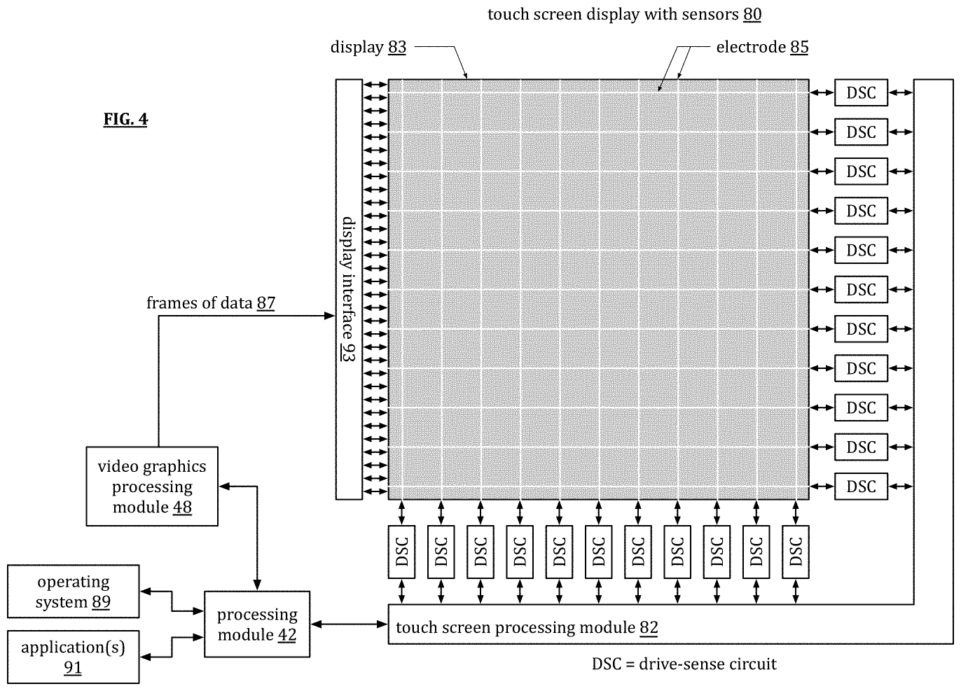

FIG. 4 is a schematic block diagram of an embodiment of a touch screen display 80 that includes a plurality of drive-sense circuits (DSC), a touch screen processing module 82, a display 83, and a plurality of electrodes 85. The touch screen display 80 is coupled to a processing module 42, a video graphics processing module 48, and a display interface 93, which are components of a computing device (e.g., 14-18), an interactive display, or other device that includes a touch screen display. An interactive display functions to provide users with an interactive experience (e.g., touch the screen to obtain information, be entertained, etc.). For example, a store provides interactive displays for customers to find certain products, to obtain coupons, to enter contests, etc.

There are a variety of other devices that include a touch screen display. For example, a vending machine includes a touch screen display to select and/or pay for an item. As another example of a device having a touch screen display is an Automated Teller Machine (ATM). As yet another example, an automobile includes a touch screen display for entertainment media control, navigation, climate control, etc. As yet a further example, a cell phone includes a touch screen display as the user interface for a wide variety of functions and/or applications.

The touch screen display 80 includes a display 83 that has a resolution equal to or greater than full high-definition (HD), an aspect ratio of a set of aspect ratios, and a screen size equal to or greater than thirty-two inches. The display 83 is one of a variety of types of displays that is operable to render frames of data into visible images. For example, the display is one or more of: a light emitting diode (LED) display, an electroluminescent display (ELD), a plasma display panel (PDP), a liquid crystal display (LCD), an LCD high performance addressing (HPA) display, an LCD thin film transistor (TFT) display, an organic light emitting diode (OLED) display, a digital light processing (DLP) display, a surface conductive electron emitter (SED) display, a field emission display (FED), a laser TV display, a carbon nanotubes display, a quantum dot display, an interferometric modulator display (IMOD), and a digital microshutter display (DMS). The display is active in a full display mode or a multiplexed display mode (i.e., only part of the display is active at a time).

The display 83 further includes integrated electrodes 85 (e.g., conductive pads coupled together to form rows, columns, and zones) that provide the sensors for the touch sense part of the touch screen display. The electrodes 85 are distributed throughout the display area or where touch screen functionality is desired. For example, a first group of the electrodes are arranged in rows, a second group of electrodes are arranged in columns, and a third group of electrodes are arranged as zones. The electrodes are electrically isolated from each other: meaning that the electrodes are not DC coupled, but could have some parasitic capacitance coupling.

The electrodes 85 are comprised of a transparent conductive material and are in-cell or on-cell with respect to layers of the display. For example, a conductive trace is placed in-cell or on-cell of a layer of the touch screen display. The transparent conductive material, which is substantially transparent and has negligible effect on video quality of the display with respect to the human eye. For instance, an electrode is constructed from one or more of: Indium Tin Oxide, Graphene, Carbon Nanotubes, Thin Metal Films, Silver Nanowires Hybrid Materials, Aluminum-doped Zinc Oxide (AZO), Amorphous Indium-Zinc Oxide, Gallium-doped Zinc Oxide (GZO), and poly polystyrene sulfonate (PEDOT).

In an example of operation, the processing module 42 is executing an operating system application 89 and one or more user applications 91. The user applications 91 includes, but is not limited to, a video playback application, a spreadsheet application, a word processing application, a computer aided drawing application, a photo display application, an image processing application, a database application, etc. While executing an application 91, the processing module generates data for display (e.g., video data, image data, text data, etc.). The processing module 42 sends the data to the video graphics processing module 48, which converts the data into frames of video 87.

The video graphics processing module 48 sends the frames of video 87 (e.g., frames of a video file, refresh rate for a word processing document, a series of images, etc.) to the display interface 93. The display interface 93 provides the frames of video to the display 83, which renders the frames of video into visible images.

While the display 83 is rendering the frames of video into visible images, the drive-sense circuits (DSC) provide sensor signals to the electrodes 85. When the screen is touched, capacitance of the electrodes 85 proximal to the touch (i.e., directly or close by) is changed. The DSCs detect the capacitance change for effected electrodes and provide the detected change to the touch screen processing module 82.

The touch screen processing module 82 processes the capacitance change of the effected electrodes to determine one or more specific locations of touch and provides this information to the processing module 42. Processing module 42 processes the one or more specific locations of touch to determine if an operation of the application is to be altered. For example, the touch is indicative of a pause command, a fast forward command, a reverse command, an increase volume command, a decrease volume command, a stop command, a select command, a delete command, etc.

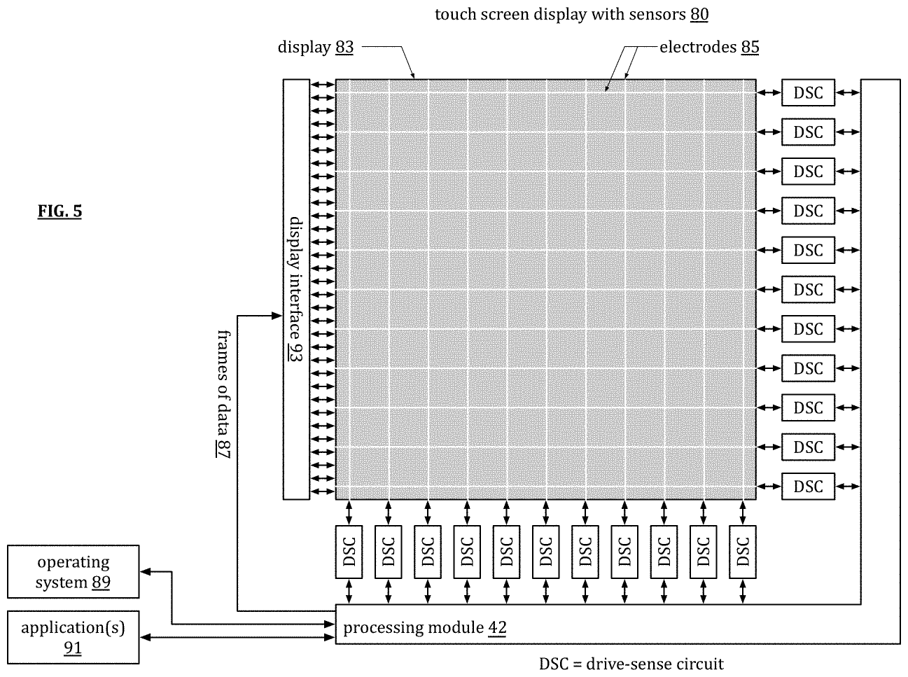

FIG. 5 is a schematic block diagram of another embodiment of a touch screen display 80 that includes a plurality of drive-sense circuits (DSC), the processing module 42, a display 83, and a plurality of electrodes 85. The processing module 42 is executing an operating system 89 and one or more user applications 91 to produce frames of data 87. The processing module 42 provides the frames of data 87 to the display interface 93. The touch screen display 80 operates similarly to the touch screen display 80 of FIG. 4 with the above noted differences.

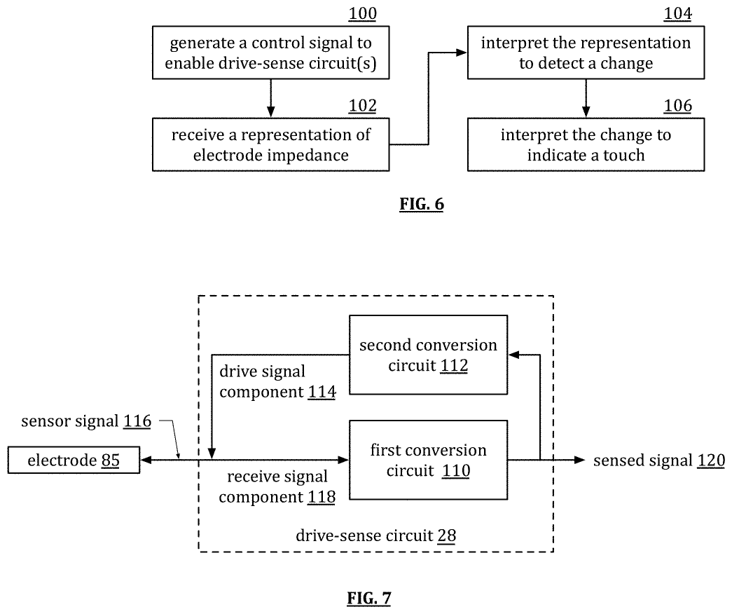

FIG. 6 is a logic diagram of an embodiment of a method for sensing a touch on a touch screen display, or on a touch screen sensor, that is executed by one or more processing modules (e.g., 42, 82, and/or 48 of the previous figures). The method begins at step 100 where the processing module generate a control signal (e.g., power enable, operation enable, etc.) to enable a drive-sense circuit to monitor the sensor signal on the electrode. The processing module generates additional control signals to enable other drive-sense circuits to monitor their respective sensor signals. In an example, the processing module enables all of the drive-sense circuits for continuous sensing for touches of the screen using a common reference signal. In another example, the processing module enables a first group of drive-sense circuits coupled to a first group of row electrodes and enables a second group of drive-sense circuits coupled to a second group of column electrodes.

The method continues at step 102 where the processing module receives a representation of the impedance on the electrode from a drive-sense circuit. In general, the drive-sense circuit provides a drive signal to the electrode. The impedance of the electrode affects the drive signal. The effect on the drive signal is interpreted by the drive-sense circuit to produce the representation of the impedance of the electrode. The processing module does this with each activated drive-sense circuit in serial, in parallel, or in a serial-parallel manner.

The method continues at step 104 where the processing module interprets the representation of the impedance on the electrode to detect a change in the impedance of the electrode. A change in the impedance is indicative of a touch. For example, an increase in self-capacitance (e.g., the capacitance of the electrode with respect to a reference (e.g., ground, etc.)) is indicative of a touch on the electrode. As another example, a decrease in mutual capacitance (e.g., the capacitance between a row electrode and a column electrode) is also indicative of a touch near the electrodes. The processing module does this for each representation of the impedance of the electrode it receives. Note that the representation of the impedance is a digital value, an analog signal, an impedance value, and/or any other analog or digital way of representing a sensor's impedance.

The method continues at step 106 where the processing module interprets the change in the impedance to indicate a touch of the touch screen display in an area corresponding to the electrode. For each change in impedance detected, the processing module indicates a touch. Further processing may be done to determine if the touch is a desired touch or an undesired touch.

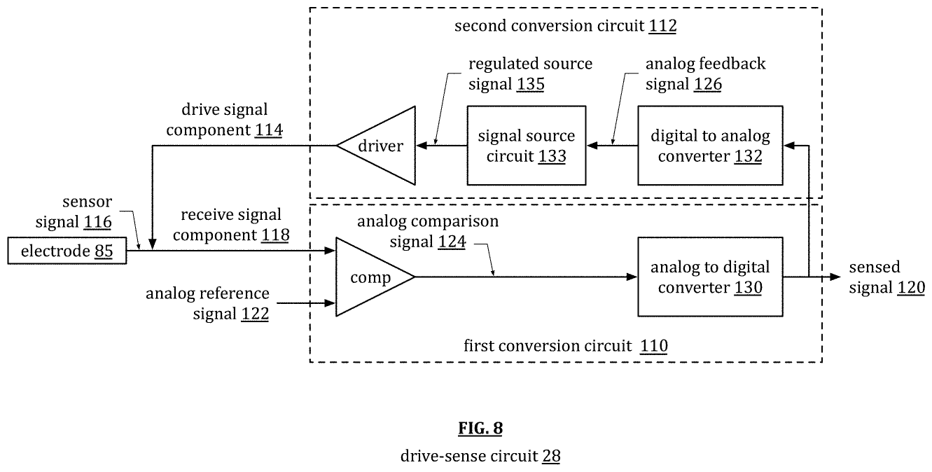

FIG. 7 is a schematic block diagram of an embodiment of a drive sense circuit 28 that includes a first conversion circuit 110 and a second conversion circuit 112. The first conversion circuit 110 converts a sensor signal 116 into a sensed signal 120. The second conversion circuit 112 generates the drive signal component 114 from the sensed signal 112. As an example, the first conversion circuit 110 functions to keep the sensor signal 116 substantially constant (e.g., substantially matching a reference signal) by creating the sensed signal 120 to correspond to changes in a receive signal component 118 of the sensor signal. The second conversion circuit 112 functions to generate a drive signal component 114 of the sensor signal based on the sensed signal 120 to substantially compensate for changes in the receive signal component 118 such that the sensor signal 116 remains substantially constant.

In an example, the drive signal 116 is provided to the electrode 85 as a regulated current signal. The regulated current (I) signal in combination with the impedance (Z) of the electrode creates an electrode voltage (V), where V=I*Z. As the impedance (Z) of electrode changes, the regulated current (I) signal is adjusted to keep the electrode voltage (V) substantially unchanged. To regulate the current signal, the first conversion circuit 110 adjusts the sensed signal 120 based on the receive signal component 118, which is indicative of the impedance of the electrode and change thereof. The second conversion circuit 112 adjusts the regulated current based on the changes to the sensed signal 120.

As another example, the drive signal 116 is provided to the electrode 85 as a regulated voltage signal. The regulated voltage (V) signal in combination with the impedance (Z) of the electrode creates an electrode current (I), where I=V/Z. As the impedance (Z) of electrode changes, the regulated voltage (V) signal is adjusted to keep the electrode current (I) substantially unchanged. To regulate the voltage signal, the first conversion circuit 110 adjusts the sensed signal 120 based on the receive signal component 118, which is indicative of the impedance of the electrode and change thereof. The second conversion circuit 112 adjusts the regulated voltage based on the changes to the sensed signal 120.

FIG. 8 is a schematic block diagram of another embodiment of a drive sense circuit 28 that includes a first conversion circuit 110 and a second conversion circuit 112. The first conversion circuit 110 includes a comparator (comp) and an analog to digital converter 130. The second conversion circuit 112 includes a digital to analog converter 132, a signal source circuit 133, and a driver.

In an example of operation, the comparator compares the sensor signal 116 to an analog reference signal 122 to produce an analog comparison signal 124. The analog reference signal 124 includes a DC component and an oscillating component. As such, the sensor signal 116 will have a substantially matching DC component and oscillating component. An example of an analog reference signal 122 will be described in greater detail with reference to FIG. 13.

The analog to digital converter 130 converts the analog comparison signal 124 into the sensed signal 120. The analog to digital converter (ADC) 130 may be implemented in a variety of ways. For example, the (ADC) 130 is one of: a flash ADC, a successive approximation ADC, a ramp-compare ADC, a Wilkinson ADC, an integrating ADC, a delta encoded ADC, and/or a sigma-delta ADC. The digital to analog converter (DAC) 214 may be a sigma-delta DAC, a pulse width modulator DAC, a binary weighted DAC, a successive approximation DAC, and/or a thermometer-coded DAC.

The digital to analog converter (DAC) 132 converts the sensed signal 120 into an analog feedback signal 126. The signal source circuit 133 (e.g., a dependent current source, a linear regulator, a DC-DC power supply, etc.) generates a regulated source signal 135 (e.g., a regulated current signal or a regulated voltage signal) based on the analog feedback signal 126. The driver increases power of the regulated source signal 135 to produce the drive signal component 114.

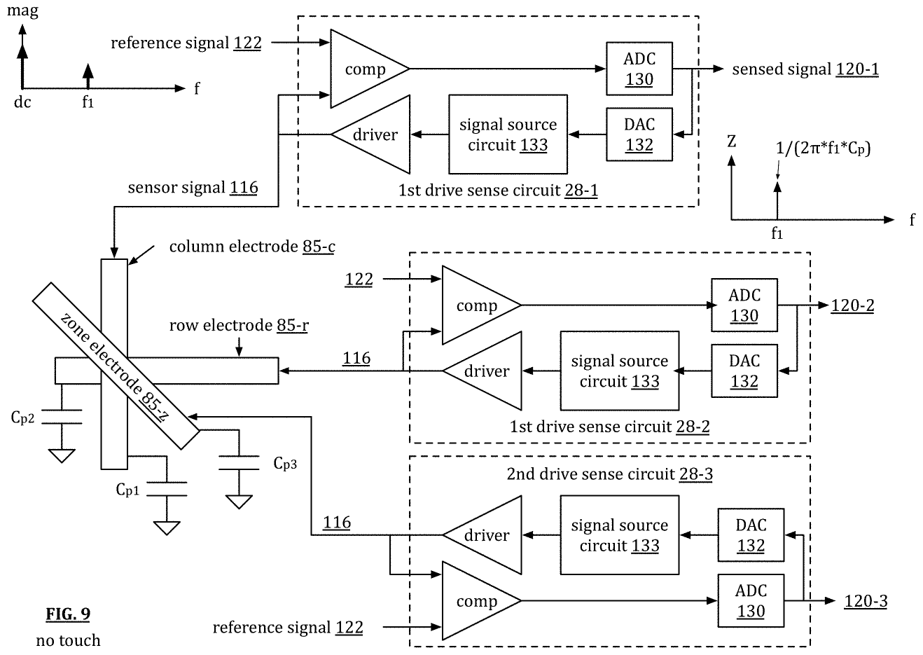

FIG. 9 is a schematic block diagram of an example of a first drive sense circuit 28-1 coupled to a column electrode 85-c, a second drive sense circuit 28-2 coupled to a row electrode 85-r, and a third drive sense circuit 28-3 coupled to a zone electrode 85-z without a touch proximal to the electrodes 85. Each of the drive sense circuits include a comparator, an analog to digital converter (ADC) 130, a digital to analog converter (DAC) 132, a signal source circuit 133, and a driver. The functionality of this embodiment of a drive sense circuit was described with reference to FIG. 8. For additional embodiments of a drive sense circuit see pending patent application entitled, “Drive Sense Circuit with Drive-Sense Line” having a filing date of Aug. 27, 2018, and an application number of Ser. No. 16/113,379.

As an example, a reference signal 122 (e.g., analog or digital) is provided to the drive sense circuits 28-1. The reference signal includes a DC component and/or an oscillating component at frequency f₁. The oscillating component corresponds to a self-capacitance measurement signal.

The first drive sense circuit 28-1 generates a sensor signal 116 based on the reference signal 122 and provides the sensor signal to the column electrode 85-c. The second drive sense circuit generates another sensor signal 116 based on the reference signal 122 and provides the sensor signal to the row electrode 85-r. The third drive sense circuit generates another sensor signal 116 based on the reference signal 122 and provides the sensor signal to the zone electrode 85-z.

In response to the sensor signals being applied to the electrodes, the first drive sense circuit 28-1 generates a first sensed signal 120-1, which includes a component at frequency f₁. The component at frequency f₁ corresponds to the self-capacitance of the column electrode 85-c. The self-capacitance is expressed as 1/(2πf₁Cₚ₁). The second drive sense circuit 28-2 generates a second sensed signal 120-2, which includes a component at frequency f₁. The component at frequency f₁ corresponds to a self-capacitance of the row electrode 85-r. The self-capacitance of the row electrode is expressed as 1/(2πf₁Cₚ₂). The third drive sense circuit 28-3 generates a third sensed signal 120-3, which includes a component at frequency f₁. The component at frequency f₁ corresponds to a self-capacitance of the zone electrode 85-z. The self-capacitance of the zone electrode is expressed as 1/(2πf₁Cₚ₃).

With each active drive sense circuit using the same frequency for self-capacitance (e.g., f₁), the row, column, and zone electrodes are at the same potential, which substantially eliminates cross-coupling between the electrodes. This provides a shielded (i.e., low noise) self-capacitance measurement for the active drive sense circuits.

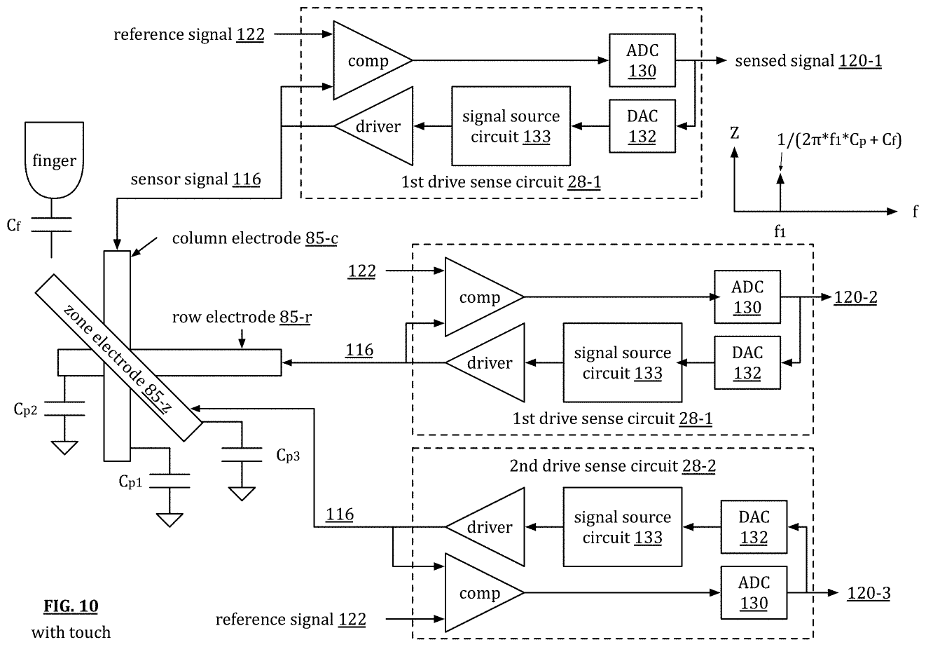

FIG. 10 is a schematic block diagram of the circuit of FIG. 9 with a finger touch proximal to the electrodes. In the presence of a finger touch that is proximal to the electrodes, the self-capacitance of the electrodes is changed.

In this example, the impedance of the self-capacitance at f₁ of the column electrode 85-c, the row electrode 85-r, and the zone electrode 85-z now includes the effect of the finger capacitance. As such, the impedance of the self-capacitance of the column electrode equals 1/(2πf₁*(Cₚ₁+C_{f})); the self-capacitance of the row electrode equals 1/(2πf₁*(Cₚ₂+C_{f})); and the self-capacitance of the zone electrode equals 1/(2πf₁*(Cₚ₃+C_{f})).

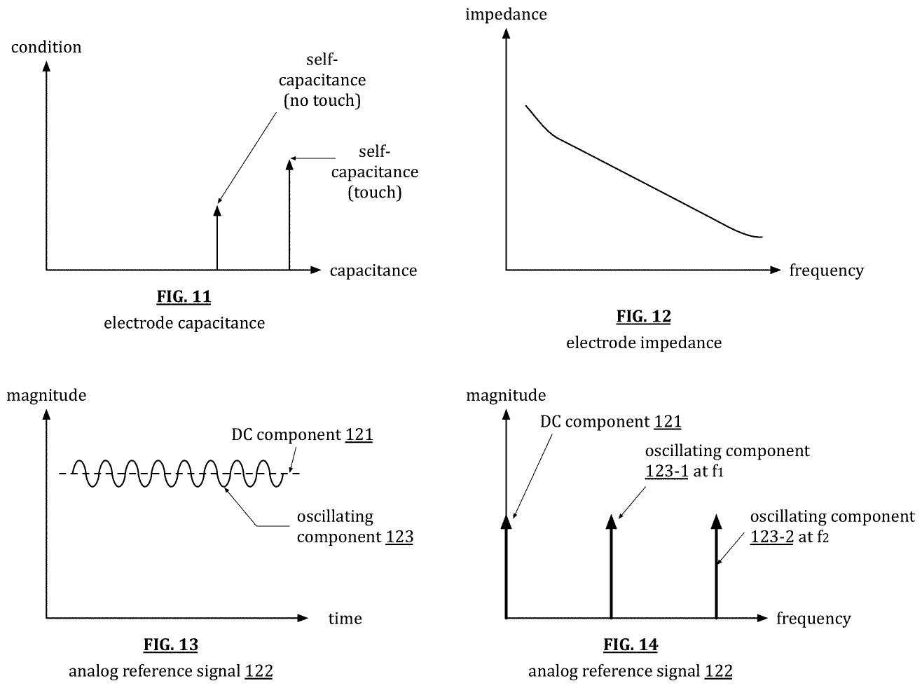

FIG. 11 is an example graph that plots condition verses capacitance for an electrode of a touch screen display. As shown, the self-capacitance increases with a touch.

FIG. 12 is an example graph that plots impedance verses frequency for an electrode of a touch screen display. Since the impedance of an electrode is primarily based on its capacitance (e.g., self), as the frequency increases for a fixed capacitance, the impedance decreases based on 1/2πf_{C}, where f is the frequency and C is the capacitance.

FIG. 13 is a time domain example graph that plots magnitude verses time for an analog reference signal 122. The analog reference signal 122 (e.g., a current signal or a voltage signal) is inputted to a comparator and is compared to the sensor signal 116. The feedback loop of the drive sense circuit 28 functions to keep the senor signal 116 substantially matching the analog reference signal 122. As such, the sensor signal 116 will have a similar waveform to that of the analog reference signal 122.

In an example, the analog reference signal 122 includes a DC component 121 and/or one or more oscillating components 123. The DC component 121 is a DC voltage in the range of a few hundred milli-volts to tens of volts or more. The oscillating component 123 includes a sinusoidal signal, a square wave signal, a triangular wave signal, a multiple level signal (e.g., has varying magnitude over time with respect to the DC component), and/or a polygonal signal (e.g., has a symmetrical or asymmetrical polygonal shape with respect to the DC component) having a fixed frequency.

In another example, the frequency of the oscillating component 123 may vary so that it can be tuned to the impedance of the sensor and/or to be off-set in frequency from other sensor signals in a system. For example, a capacitance sensor's impedance decreases with frequency. As such, if the frequency of the oscillating component is too high with respect to the capacitance, the capacitor looks like a short and variances in capacitances will be missed. Similarly, if the frequency of the oscillating component is too low with respect to the capacitance, the capacitor looks like an open and variances in capacitances will be missed.

FIG. 14 is a frequency domain example graph that plots magnitude verses frequency for an analog reference signal 122. As shown, the analog reference signal 122 includes the DC component 121 at DC (e.g., 0 Hz or near 0 Hz), a first oscillating component 123-1 at a first frequency (f₁), and a second oscillating component 123-2 at a second frequency (f₂). In an example, the DC component is used to measure resistance of an electrode (if desired), the first oscillating component 123-1 is used to measure the impedance of self-capacitance, and the second oscillating component 123-2 is used to measure the impedance of mutual-capacitance. Note that the second frequency may be greater than the first frequency.

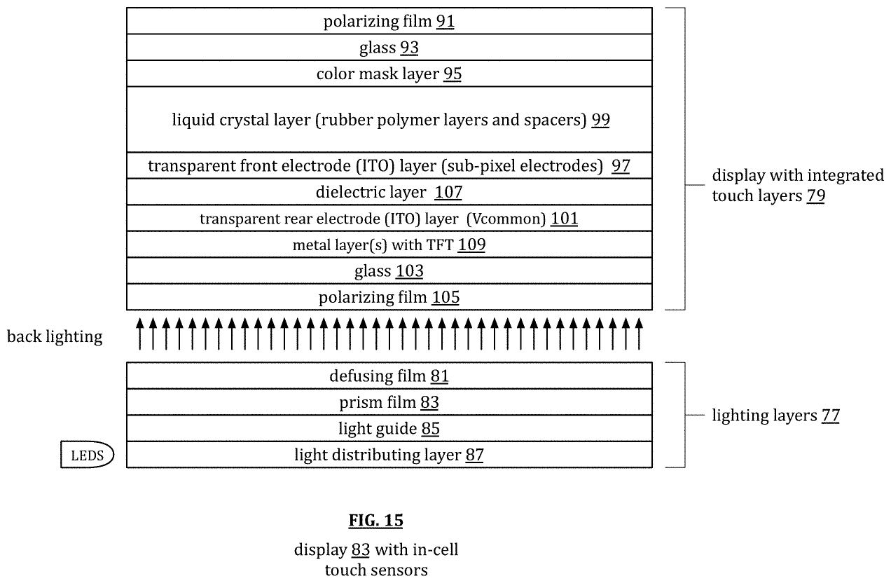

FIG. 15 is a cross section schematic block diagram of an example of a touch screen display 83 with in-cell touch screen sensors, which includes lighting layers 77 and display with integrated touch sensing layers 79. The lighting layers 77 include a light distributing layer 87, a light guide layer 85, a prism film layer 83, and a defusing film layer 81. The display with integrated touch sensing layers 79 include a rear polarizing film layer 105, a glass layer 103, one or more metal layers (which may include thin-film-transistors (TFT)), a V_common transparent electrode layer 101, a dielectric layer 107, a sub-pixel electrode layer 97, a liquid crystal layer (e.g., a rubber polymer layer with spacers) 99, a color mask layer 95, a glass layer 93, and a front polarizing film layer 91. Note that one or more protective layers may be applied over the polarizing film layer 91. Further note that this is one of many touch screen display implementations. Others include electrodes on both sides of the LCD layer.

In an example of operation, a row of LEDs (light emitted diodes) projects light into the light distributing player 87, which projects the light towards the light guide 85. The light guide includes a plurality of holes that let's some light components pass at differing angles. The prism film layer 83 increases perpendicularity of the light components, which are then defused by the defusing film layer 81 to provide a substantially even back lighting for the display with integrated touch sense layers 79.

The two polarizing film layers 105 and 91 are orientated to block the light (i.e., no light, so it appears black). The electrode layer 97 and the V_common layer 101 create an electric field at a sub-pixel level to orientate liquid crystals in the liquid crystal layer 99 to twist the light. When the electric field is off, or is very low, the liquid crystals are orientated in a first manner (e.g., end-to-end) that does not twist the light, thus, for the sub-pixel, the two polarizing film layers 105 and 91 are blocking the light. As the electric field is increased, the orientation of the liquid crystals change such that the two polarizing film layers 105 and 91 pass the light (e.g., white light). When the liquid crystals are in a second orientation (e.g., side by side), intensity of the light is at its highest point.

The color mask layer 95 includes three sub-pixel color masks (red, green, and blue) for each pixel of the display, which includes a plurality of pixels (e.g., 1440×1080). As the electric field produced by electrodes change the orientations of the liquid crystals at the sub-pixel level, the light is twisted to produce varying sub-pixel brightness. The sub-pixel light passes through its corresponding sub-pixel color mask to produce a color component for the pixel. The varying brightness of the three sub-pixel colors (red, green, and blue), collectively produce a single color to the human eye. For example, a blue shirt has a 12% red component, a 20% green component, and 55% blue component.

Metal traces connecting the sub-pixel electrodes to the display circuitry are in the metal layers 109 along with the thin film transistors (TFT). The metal traces and TFTs are connected to the sub-pixel electrodes using vias. The metal traces are positioned between the sub-pixel electrodes (from a top down perspective) such that they do not interfere with the video quality of the display. In an example, gate line traces are on one metal layer and data line traces are on another metal layer. The metal layers are also used for connections to the conductive pads of the V_common layer 101, which form a layer of the touch screen sensor.

The in-cell touch sense functionality uses the existing layers of the display layers 79 to provide capacitance-based sensors. For instance, one or more of the transparent sub-pixel electrode layer 97 and the V_common layer 101 are used to provide one or more sets of row electrodes and column electrodes. Various examples of creating row and column electrodes from one or more of the sub-pixel electrode layer 97 and the V_common layer 101 are discussed in some of the subsequent figures.

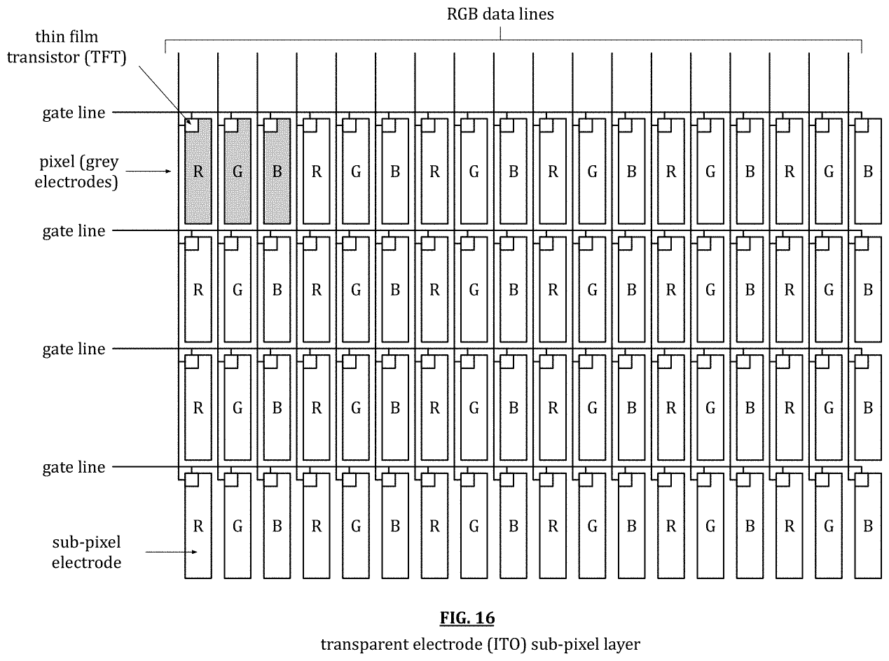

FIG. 16 is a schematic block diagram of an example of a transparent sub-pixel electrode layer 97 coupled to thin film transistors (TFT), which are on a different layer (e.g., one or more of the metal layers). Sub-pixel electrodes are formed on the transparent electrode layer and each sub-pixel electrode is coupled to a thin film transistor (TFT). Three sub-pixels (R-red, G-green, and B-blue) form a pixel. The gates of the TFTs associated with a row of sub-electrodes are coupled to a common gate line. In this example, each of the four rows has its own gate line. The drains (or sources) of the TFTs associated with a column of sub-electrodes are coupled to a common R, B, or G data line. The sources (or drains) of the TFTs are coupled to its corresponding sub-electrode.

In an example of operation, one gate line is activated at a time and RGB data for each pixel of the corresponding row is placed on the RGB data lines. At the next time interval, another gate line is activated and the RGB data for the pixels of that row is placed on the RGB data lines. For 1080 rows and a refresh rate of 60 Hz, each row is activated for about 15 microseconds each time it is activated, which is 60 times per second. When the sub-pixels of a row are not activated, the liquid crystal layer holds at least some of the charge to keep an orientation of the liquid crystals.

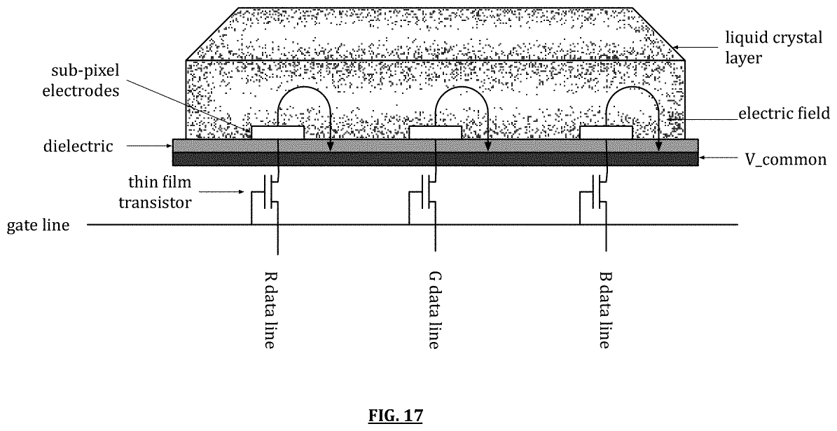

FIG. 17 is a schematic block diagram of an example of a pixel with three sub-pixels (R-red, G-green, and B-blue). In this example, the sub-pixel electrodes are formed in the front transparent sub-pixel layer 97 and the return electrodes are formed in the transparent V_common layer 101. Each sub-pixel electrode is coupled to a corresponding thin film transistor. The thin film transistors coupled to the sub-pixel electrodes are coupled to a gate line and to R, G, and B data lines.

To create an electric field from the sub-pixel electrodes and V_common, a gate signal is applied to the gate lines and differential R, G, and B data signals are applied to the R, G, and B data lines. For example, for the red (R) sub-pixel, the thin film transistor is activated by the signal on the gate lines. The electric field created by the red sub-pixel electrodes is depending on the Red data signal. As a specific example, a large voltage creates a large electric field, which twists the light towards maximum light passing and increases the red component of the pixel.

The gate lines and data lines are non-transparent wires (e.g., copper) that are positioned) between the sub-pixel electrodes such that they are hidden from human sight. The non-transparent wires may be on the same layer as the sub-pixel electrodes or on different layers and coupled using vias. The connections coupling conductive pads of rows, columns, and zones are non-transparent wires (e.g., copper) that are also positioned between the sub-pixel electrodes on the same layer of different layer of the display.

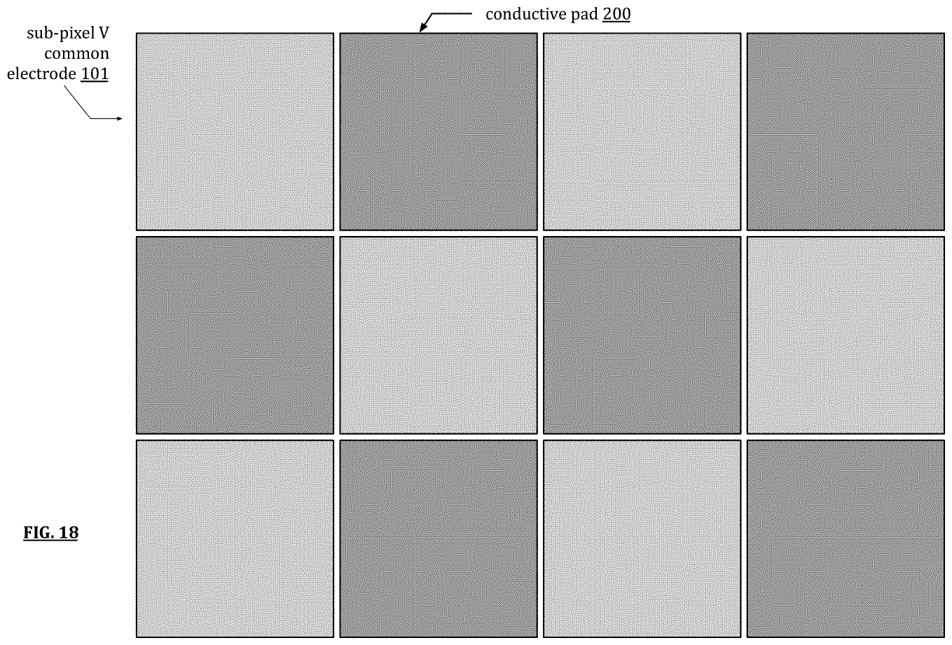

FIG. 18 is a schematic block diagram of an example of the V_common layer 101 (e.g., common voltage layer) sectioned to form conductive pads 200. As discussed below, the conductive pads 200 are arranged in a variety of ways to create, row, column, and zone electrodes of a touch screen sensor. In this example, 3 rows and 4 columns of conductive pads 200 are created. As an example, a conductive pad 200 has a size of 5 mm by 5 mm, but could be larger or smaller, and/or could a shape other than square. As a further example, the V_common layer 101 may be divided into many more conductive pads than the 12 shown.

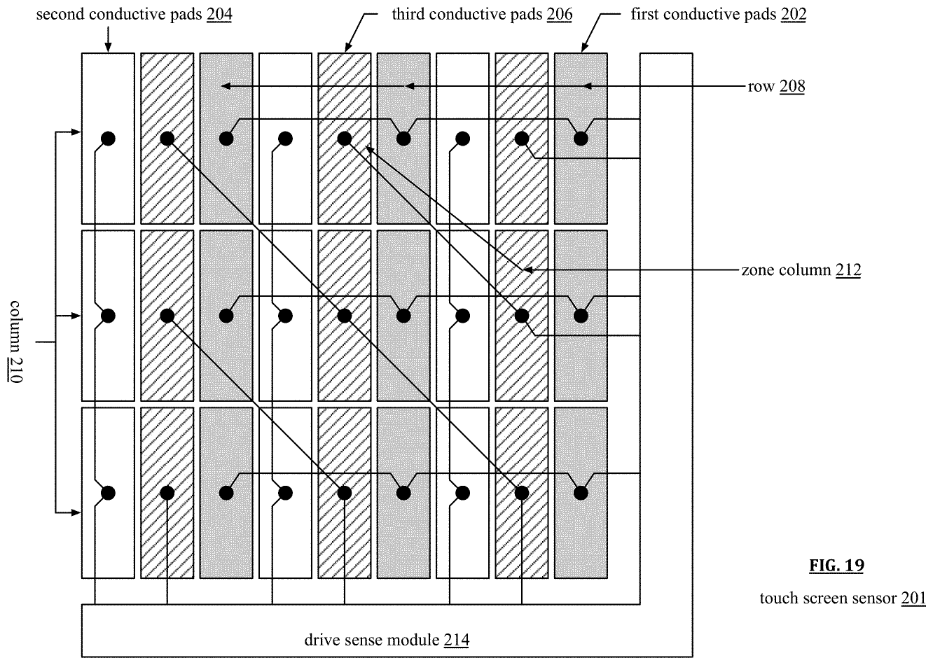

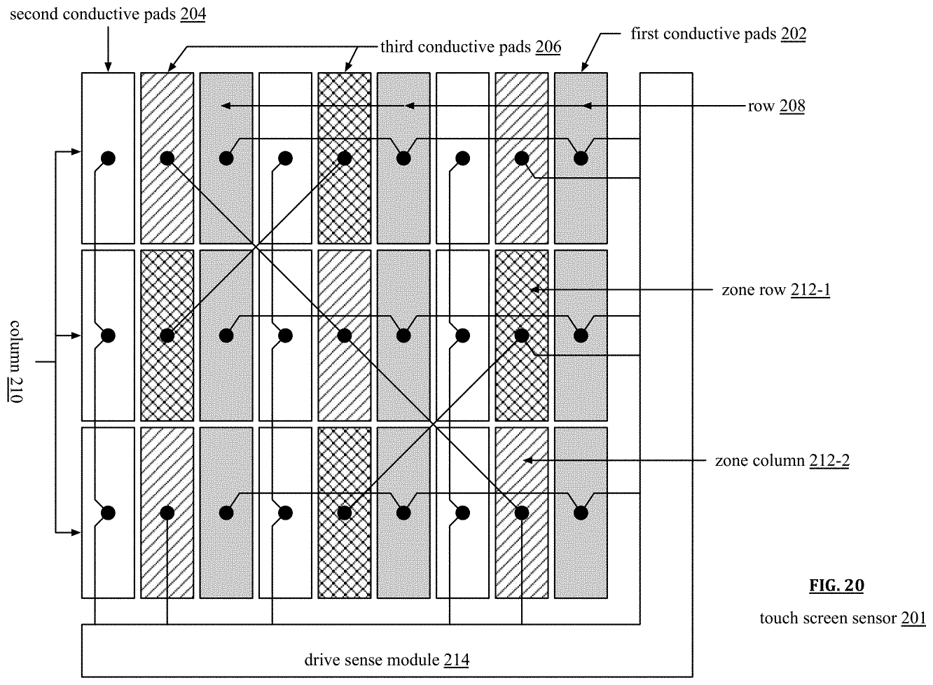

FIG. 19 is a schematic block diagram of an example of conductive pads 202-206 of a touch screen sensor 201 coupled together to form in-cell or on-cell electrodes of rows 208, columns 210, and zones 212. In this embodiment, a first set of conductive pads 202 (white fill) is coupled together to form rows 208 of electrodes; a second set of conductive pads 204 (grey fill) is coupled together to form columns 210 of electrodes; and a third set of conductive pads 206 (cross-hatch fill) is coupled together form zones 212 of electrodes. The rows 208, the columns 210, and the zones 212 are electrically isolated from each other (meaning they are not DC coupled together, but they could have some parasitic capacitance coupling). In an example, the rows 208 have a first orientation (e.g., horizontal), the columns have a second orientation (e.g., vertical), and the zones 212 have a third orientation (e.g., diagonal).

In this configuration, the rows 208 and columns 210 form a first touch grid and the zones 212 form a second touch grid. The drive-sense module 214, which includes a plurality of drive sense circuits and a processing module, drives signals on to the rows 208, the columns 210, and the zones 212. In an embodiment, the signals are generated from a common reference signal (e.g., 122 of FIGS. 9 and 10) that has a DC component and an oscillating component (e.g., f1_. As such, the signals driving the rows, the columns, and the zones have the same signal characteristics for detecting self-capacitance on the electrodes of the rows, columns and zones. In furtherance of this embodiment, the signals are driven on to the row, column, and zone electrodes concurrently.

In another embodiment, the drive sense module 214 generate the signals for driving the electrodes of the rows 208 and the columns 210 from a first common reference signal that has a first DC component and a first oscillating component (e.g., f1). The drive sense module 214 further generates the signals for driving the electrodes of zones 212 from a second common reference signal that has a second DC component and a second oscillating component (e.g., f2).

In this embodiment, the drive sense module senses self-capacitance of the electrodes of the rows and columns based on the first oscillating frequency (f1) and senses self-capacitance of the electrodes of the zones based on the second oscillating frequency (f2). In addition, the drive sense module 214 senses mutual capacitance between the zone electrodes and the row electrodes and between the zone electrodes and the column electrodes. The drive sense module 214 uses the mutual capacitance sensing to augment the self-capacitance sensing to detect touches on the screen.

The conductive pads forming the electrodes of the rows, columns, and zones may be on one or more layers of a touch screen sensor and/or on a touch screen display. For example, the conductive pads are on the same ITO layer of a touch screen display, such as the back layer or the common voltage layer. As another example, the conductive pads of the rows and columns are on one layer and the conductive pads of the zones are on another layer. Regardless of whether the conductive pads are on the same layer or different layers, a first plurality of connecting traces on a second layer couples the first set of conductive pads together to form the electrodes of the rows; a second plurality of connecting traces on the second layer couples the second set of conductive pads together to form the electrodes of the columns; and a third plurality of connecting traces on the second layer couples the third set of conductive pads together to form the electrodes of the zones.

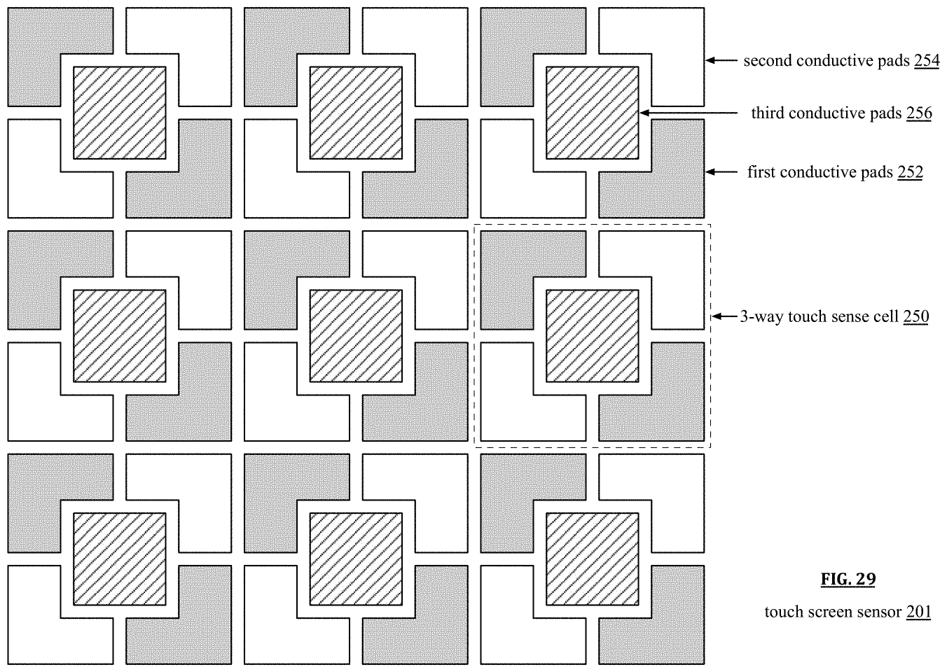

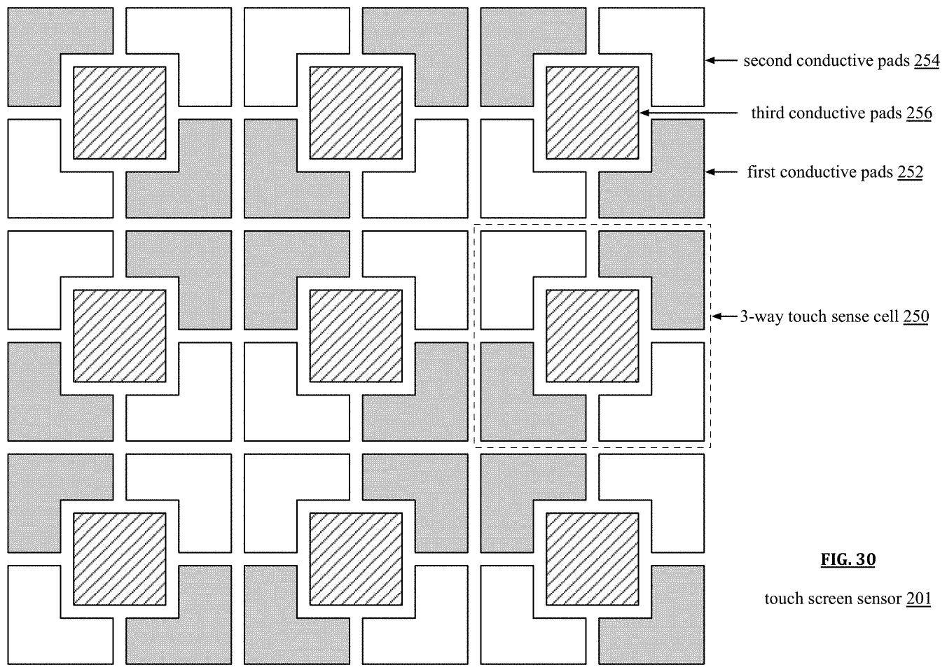

With respect to the third conductive pads 206, they are diagonally coupled in one direction to form the electrodes of the zones 212. Each zone electrode is coupled to the drive sense module 214, which individually drives and senses the zone electrodes. With the addition of the zone electrodes, self-capacitance variance detection can be used to detect true touches and disregard false touches. An example is provided with reference to FIGS. 28 and 29.

FIG. 20 is a schematic block diagram of another example of conductive pads 202-206 of a touch screen sensor 201 coupled together to form electrodes of rows 208, columns 210, and zones 212. This example is similar to the example of FIG. 19 with the different being how the third conductive pads 206 are coupled together to form electrodes of the zones 212. In this example, the third conductive pads 206 are coupled together to form zone rows 212-1 and zone columns 212-2. This provides a second row-column grid for detecting true touches and discarding false touches.

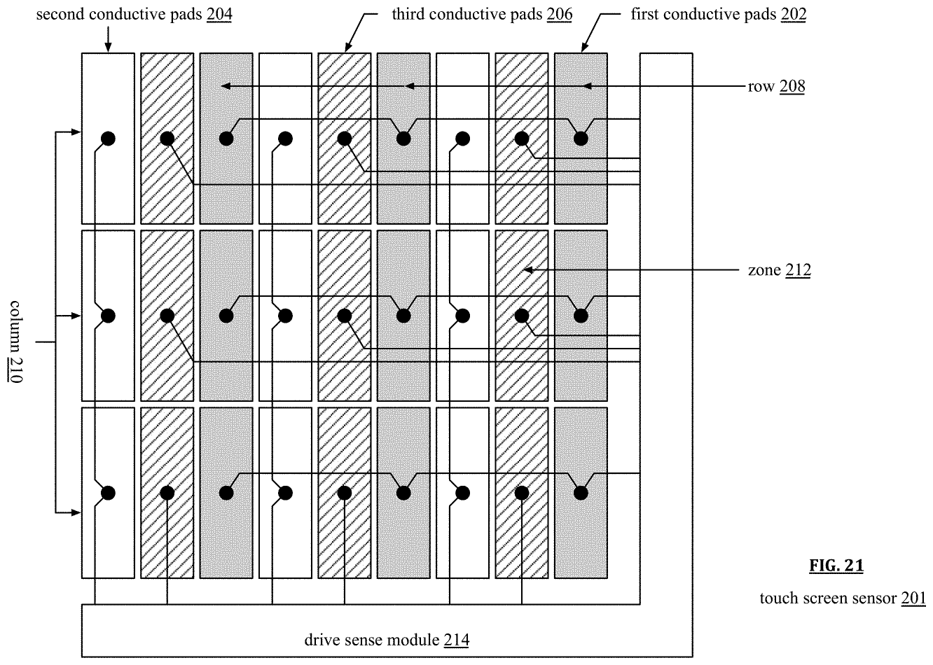

FIG. 21 is a schematic block diagram of another example of conductive pads 202-206 of a touch screen sensor 201 coupled together to form electrodes of rows 208, columns 210, and zones 212. This example is similar to the example of FIG. 19 with the different being how the third conductive pads 206 are coupled together to form electrodes of the zones 212. In this example, each third conductive pads 206 is its own zone electrode 212. This provides a capacitance touch sensor grid of zones 212 to support the row-column grid (208 and 210) for detecting true touches and discarding false touches.

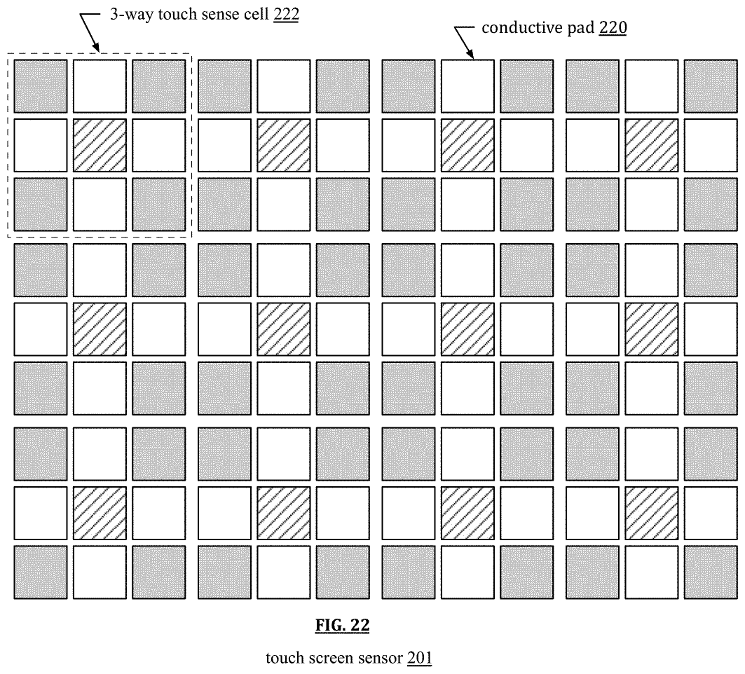

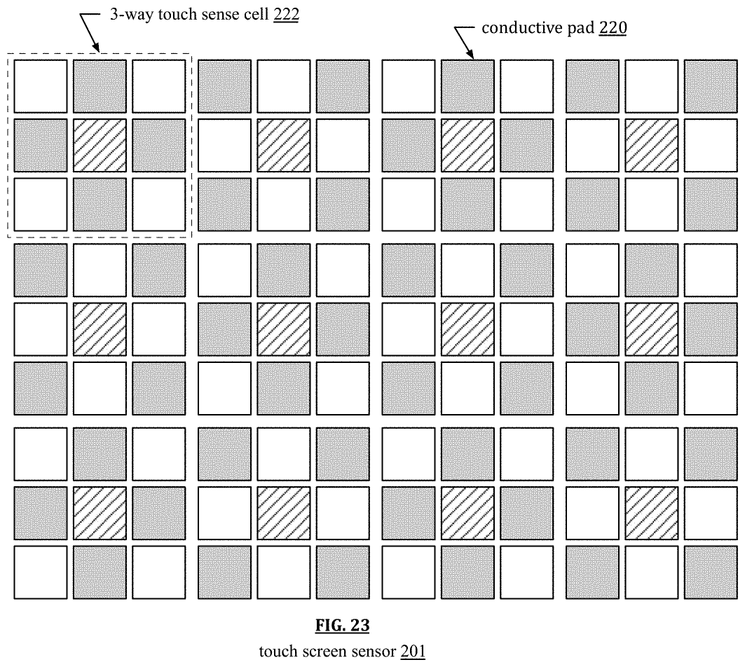

FIG. 22 is a schematic block diagram of an example of a pattern of conductive pads 220 forming three-way touch sense cells 222 of a touch screen sensor 201, which may be a stand-alone sensor or included in a touch screen display. In this example, the grey shaded conductive pads 220 are at the corners of a 3-way touch sense cell 222, the white shaded conductive pads 220 are positioned in a cross pattern within the 3-way touch sense cell 222; and the cross-hatch shaded conductive pad 220 is in the center of 3-way touch sense cell 222. This pattern of conductive pad positioning within a 3-way touch sense cell 222 is repeated from cell 222 to cell 222.

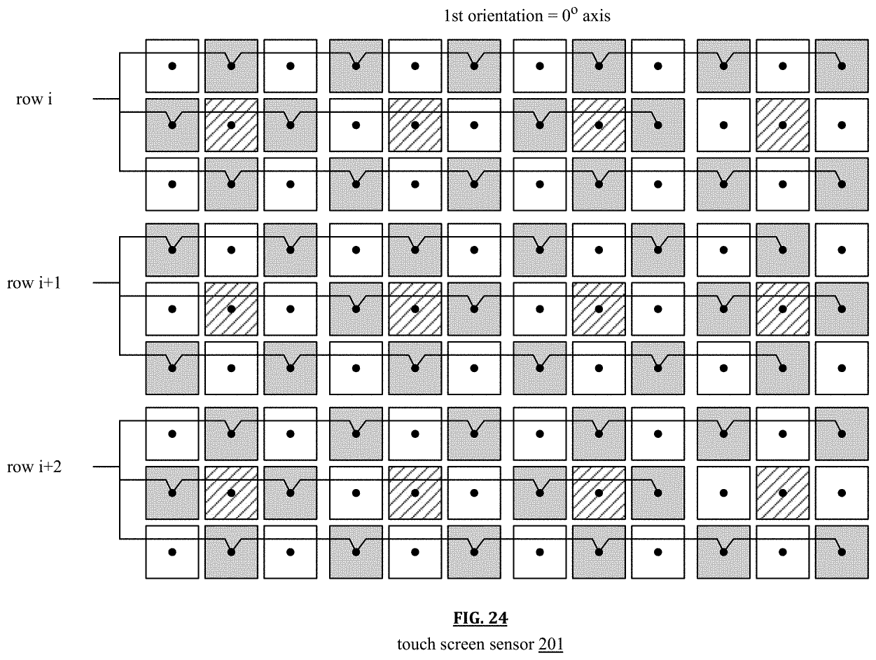

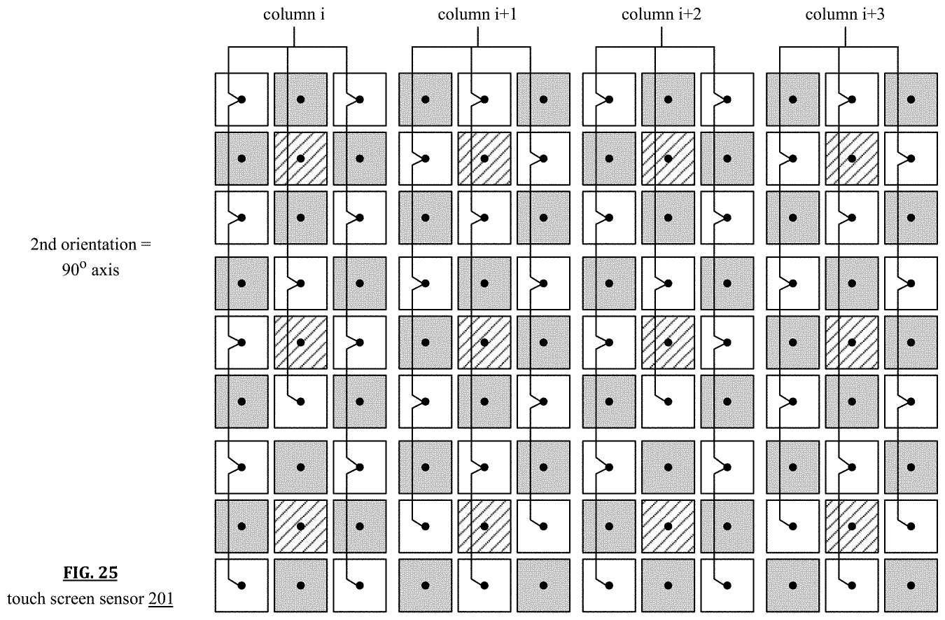

Various embodiments of coupling the conductive pads 220 together to form rows, columns, and zones are discussed below with reference to FIGS. 24-26. Note that the size of the 3-way touch sense cell 222 may be of any desired size and its shape may be any desired shape (e.g., a diamond, a rectangle, a polygon, etc.). Further, the number of conductive pads in a 3-way touch sense cell 222 may be more or less than nine. Still further note that the shape of the conductive pads 200 may be of any desired shape and the size, from pad to pad, may vary.

FIG. 23 is a schematic block diagram of another example of a pattern of conductive pads 220 forming three-way touch sense cells 222 of a touch screen sensor 201, which may be a stand-alone sensor or included in a touch screen display. In this example, some of the 3-way touch sense cells 222 include the grey shaded conductive pads 220 in the corners, the white shaded conductive pads 220 in a cross pattern; and the cross-hatch shaded conductive pad 220 in the center. Other the 3-way touch sense cells 222 include the white shaded conductive pads 220 in the corners, the grey shaded conductive pads 220 in a cross pattern; and the cross-hatch shaded conductive pad 220 in the center. This alternating pattern of conductive pad positioning within a 3-way touch sense cell 222 is repeated from cell 222 to cell 222. Various embodiments of coupling the conductive pads 220 together to form rows, columns, and zones are discussed below with reference to FIGS. 24-26.

FIG. 24 is a schematic block diagram of an example of conductive pads forming rows (row i through row i+2) in a touch screen sensor 201. As shown, the grey shaded conductive pads are coupled together to form rows i through i+2. The rows have a first orientation, which corresponds to a zero-degree axis.

FIG. 25 is a schematic block diagram of an example of conductive pads forming columns (column i through column i+3) in a touch screen sensor 201. As shown, the white shaded conductive pads are coupled together to form columns i through i+3. The columns have a second orientation, which corresponds to a 90-degree axis.

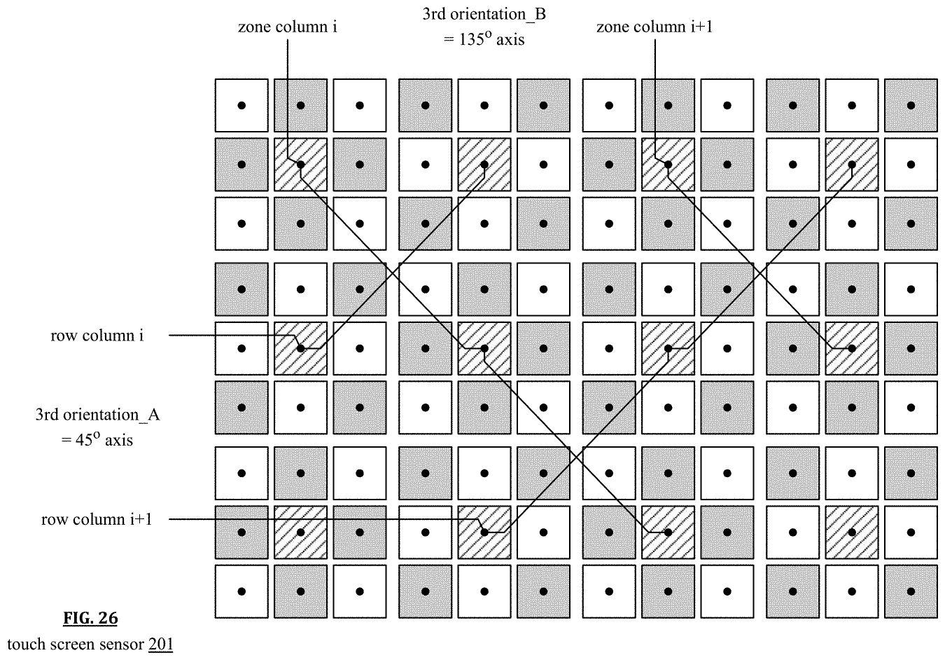

FIG. 26 is a schematic block diagram of an example of conductive pads forming zones columns (i through i+1) and zone rows (i through i+1) in a touch screen sensor 201. As shown, some of the cross hatch shaded conductive pads are coupled together to form zone columns i through i+1 and the other cross hatch shaded conductive pads are coupled together to form zone rows i through i+1. The zone rows have a third_A orientation, which corresponds to a 45-degree axis and the zone columns have a third_B orienations, which corresponds to a 135-degree axis.

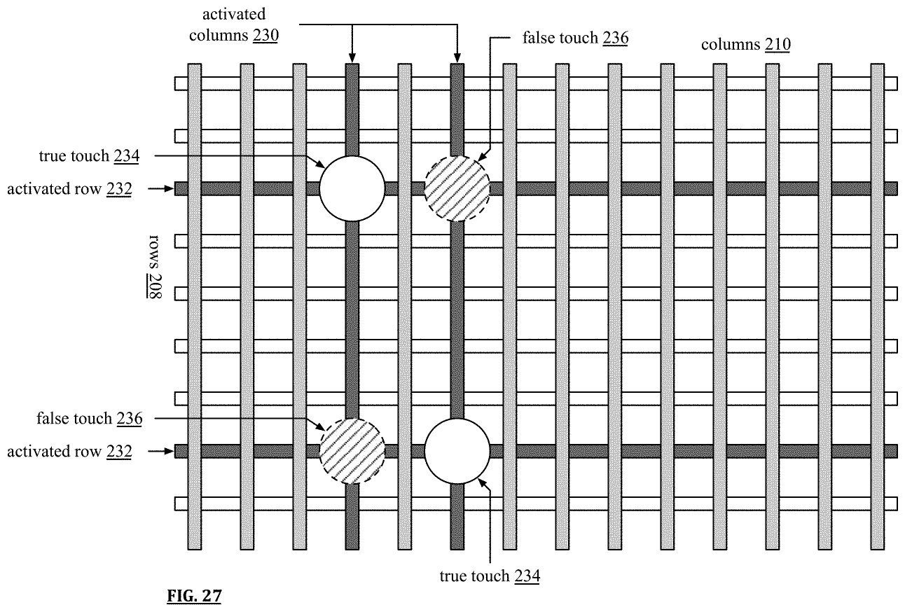

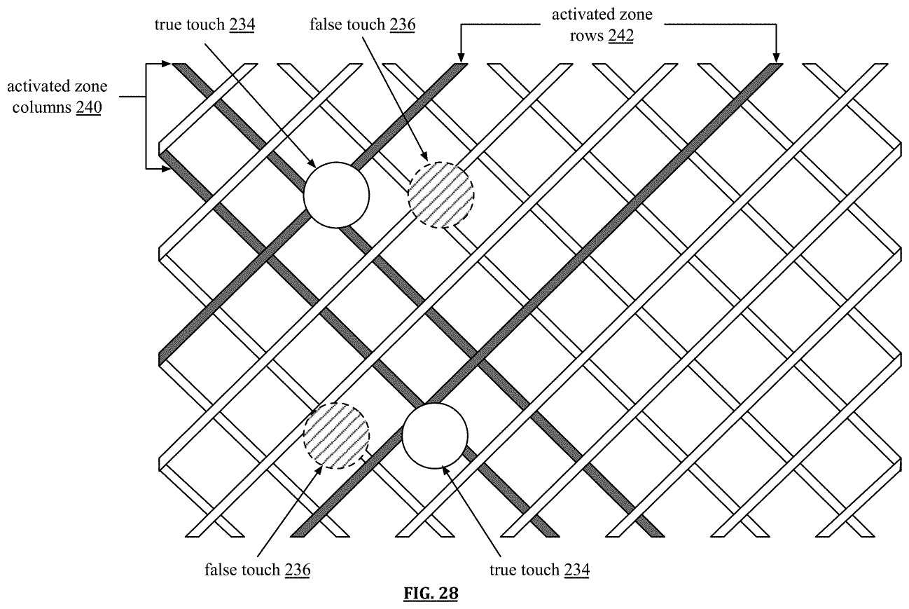

FIG. 27 is a schematic block diagram of an example of touches activating rows 232 and columns 230 of the rows 208 and columns 210 of a touch screen sensor 201. In this example, two true touches 234 (a finger is proximal to the screen changing self-capacitance of the activated electrodes) are present. The true touches 234 activate two rows 232 and two columns 230. With just rows and columns in self-capacitance mode, two false touches 236 are present. Since, with just the active rows and columns as input to the drive sense module, the active rows and columns could be activated by touches in the true touch locations or in the false touch locations. Without further information, the drive sense module cannot distinguish between true and false touches. With the includes of the zone electrodes, the drive sense module is provided additional information to determine between true and false touches.

FIG. 28 is a schematic block diagram of an example of touches activating zone rows 242 and zone columns 240 based on true touches 234. With the addition of the activated zone rows and columns, the drive sense module, using the activated rows and columns of FIG. 28, can readily determine between true touches and false touches using self-capacitance variance detection.

FIG. 29 is a schematic block diagram of another example of a pattern of conductive pads 252-256 forming three-way touch sense cells 250 of a touch screen sensor 201, which may be a stand-alone sensor or included in a touch screen display. In this example, the first, or grey shaded, conductive pads 252 are at opposite corners of a 3-way touch sense cell 250, the second, white shaded, conductive pads 254 are at the other opposite corners of the 3-way touch sense cell 250; and the third, or cross-hatch shaded, conductive pad 256 is in the center of 3-way touch sense cell 222. This pattern of conductive pad positioning within a 3-way touch sense cell 250 is repeated from cell 250 to cell 250.

FIG. 30 is a schematic block diagram of another example of a pattern of conductive pads 252-256 forming three-way touch sense cells 250 of a touch screen sensor 201, which may be a stand-alone sensor or included in a touch screen display. In this example, some of the three-way touch sense cells 250 have the first, or grey shaded, conductive pads 252 are at opposite corners of a 3-way touch sense cell 250, have the second, white shaded, conductive pads 254 are at the other opposite corners of the 3-way touch sense cell 250; and have the third, or cross-hatch shaded, conductive pad 256 is in the center of 3-way touch sense cell 222. In other cells 250, the orientation of the cell is rotated 90-degrees. This alternating pattern of conductive pad positioning within a 3-way touch sense cell 250 is repeated among the cells 250.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A touch screen sensor comprises:
a first set of conductive pads coupled to form a plurality of rows;
a second set of conductive pads coupled to form a plurality of columns, wherein the plurality of rows is electrically isolated from the plurality of columns, wherein the plurality of rows has a first orientation and the plurality of columns has a second orientation, and wherein the first orientation and the second orientation form a first touch grid;
a third set of conductive pads coupled to form a plurality of zones, wherein the plurality of zones is electrically isolated from the plurality of rows and from the plurality of columns, wherein the plurality of zones has a third orientation that forms a second touch grid; and
a drive-sense module coupled to the rows, columns, and touch sensing zones, wherein the drive-sense circuit is operable to:
drive signals on to the plurality of rows, the plurality of columns, and the plurality of zones;
sense an electrical characteristic of the plurality of row, the plurality of columns, and the plurality of zones based on the signals; and
determine one or more touches on the touch screen sensor based on the sensed electrical characteristics.

2. The touch screen sensor of claim 1 further comprises:
the first set of conductive pads, the second set of conductive pads, and the third set of conductive pads are on a same substantially transparent and conductive layer of the touch screen sensor.

3. The touch screen sensor of claim 1 further comprises:
a first plurality of connecting traces on a second layer of a touch screen display that includes the touch screen sensor, wherein the first plurality of connecting traces couples the first set of conductive pads, which is on a first layer of the touch screen display, together to form the plurality of rows;
a second plurality of connecting traces on the second layer that couples the second set of conductive pads, which is on the first layer, together to form the plurality of columns; and
a third plurality of connecting traces on the second layer that couples the third set of conductive pads, which is on the first layer, together to form the plurality of zones.

4. The touch screen sensor of claim 1, wherein the drive sense module is further operable to:
generate the signals from a common reference signal that has a DC component and an oscillating component such that the signals driving the plurality of rows, the plurality of columns, and the plurality of zones have the same signal characteristics.

5. The touch screen sensor of claim 1, wherein the drive sense module is further operable to:
generate the signals for driving the plurality of rows and the plurality of columns from a first common reference signal that has a first DC component and a first oscillating component; and
generate the signals for driving the plurality of zones from a second common reference signal that has a second DC component and a second oscillating component.

6. The touch screen sensor of claim 1 further comprises:
a first subset of the first set of conductive pads, a first subset of the second set of conductive pads, and a first subset set of the third set of conductive pads form a first block;
a second subset of the first set of conductive pads, a second subset of the second set of conductive pads, and a second subset set of the third set of conductive pads form a second block;
a third subset of the first set of conductive pads, a third subset of the second set of conductive pads, and a third subset set of the third set of conductive pads form a third block; and
a fourth subset of the first set of conductive pads, a fourth subset of the second set of conductive pads, and a fourth subset set of the third set of conductive pads form a fourth block, wherein the first, second, third, and fourth blocks form block rows and block columns.

7. The touch screen sensor of claim 6 further comprises:
the first subset of the first set of conductive pads includes four first conductive pads;
the first subset of the second set of conductive pads includes four second conductive pads; and
the first subset of the third set of conductive pads includes one third conductive pad, wherein the first block has a substantially square shape, wherein the four first conductors are positioned at corners of the substantially square shape, wherein the four second conductors are positioned in a cross pattern of the substantially square shape, and the one third conductive pad is positioned at a center of the substantially square shape.

8. The touch screen sensor of claim 7 further comprises:
the second subset of the first set of conductive pads includes another four first conductive pads;
the second subset of the second set of conductive pads includes another four second conductive pads; and
the second subset of the third set of conductive pads includes another one third conductive pad, wherein the second block has the substantially square shape, wherein the another four first conductors are positioned at corners of the substantially square shape, wherein the another four second conductors are positioned in a cross pattern of the substantially square shape, and the another one third conductive pad is positioned at a center of the substantially square shape.

9. The touch screen sensor of claim 7 further comprises:
the second subset of the first set of conductive pads includes another four first conductive pads;
the second subset of the second set of conductive pads includes another four second conductive pads; and
the second subset of the third set of conductive pads includes another one third conductive pad, wherein the second block has the substantially square shape, wherein the another four second conductors are positioned at corners of the substantially square shape, wherein the another four first conductors are positioned in a cross pattern of the substantially square shape, and the another one third conductive pad is positioned at a center of the substantially square shape.

10. The touch screen sensor of claim 1 further comprises:
the third set of conductive pads is coupled to form a second plurality of rows and a second plurality of columns as the plurality of zones, wherein the first orientation is along a 0 degree axis, wherein the second orientation is along a 90 degree axis, and wherein the third orientation includes a 45 degree axis for the second plurality of rows and a 135 degree axis for the second plurality of columns.

11. A touch screen display comprises:
a display that includes:
a substantially transparent common voltage layer;
a pixel section operably coupled to the substantially transparent common voltage layer, wherein the pixel section converts digital data into an image; and
a cover section overlaying the pixel section; and
a touch screen sensor that includes:
a first set of conductive pads coupled to form a plurality of rows;
a second set of conductive pads coupled to form a plurality of columns, wherein the plurality of rows is electrically isolated from the plurality of columns, wherein the plurality of rows has a first orientation and the plurality of columns has a second orientation, and wherein the first orientation and the second orientation form a first touch grid;
a third set of conductive pads coupled to form a plurality of zones, wherein the plurality of zones is electrically isolated from the plurality of rows and from the plurality of columns, wherein the plurality of zones has a third orientation that forms a second touch grid; and
a drive-sense module coupled to the rows, columns, and touch sensing zones, wherein the drive-sense circuit is operable to:
drive signals on to the plurality of rows, the plurality of columns, and the plurality of zones;
sense an electrical characteristic of the plurality of row, the plurality of columns, and the plurality of zones based on the signals; and
determine one or more touches on the touch screen sensor based on the sensed electrical characteristics.

12. The touch screen display of claim 11 further comprises:
the first set of conductive pads, the second set of conductive pads, and the third set of conductive pads are formed on the substantially transparent common voltage layer.

13. The touch screen display of claim 11 further comprises:
a first plurality of connecting traces on at least one of a gate metal layer of the display and a data metal layer of the display, wherein the first plurality of connecting traces couples the first set of conductive pads to form the plurality of rows;
a second plurality of connecting traces on the at least one of the gate metal layer of and the data metal layer, wherein the second plurality of connecting traces couples the second set of conductive pads together to form the plurality of columns; and
a third plurality of connecting traces on the at least one of the gate metal layer of and the data metal layer, wherein the third plurality of connecting traces couples the third set of conductive pads together to form the plurality of zones.

14. The touch screen display of claim 11, wherein the drive sense module is further operable to:
generate the signals from a common reference signal that has a DC component and an oscillating component such that the signals driving the plurality of rows, the plurality of columns, and the plurality of zones have the same signal characteristics.

15. The touch screen display of claim 11, wherein the drive sense module is further operable to:
generate the signals for driving the plurality of rows and the plurality of columns from a first common reference signal that has a first DC component and a first oscillating component; and
generate the signals for driving the plurality of zones from a second common reference signal that has a second DC component and a second oscillating component.

16. The touch screen display of claim 11 further comprises:
a first subset of the first set of conductive pads, a first subset of the second set of conductive pads, and a first subset set of the third set of conductive pads form a first block;
a second subset of the first set of conductive pads, a second subset of the second set of conductive pads, and a second subset set of the third set of conductive pads form a second block;
a third subset of the first set of conductive pads, a third subset of the second set of conductive pads, and a third subset set of the third set of conductive pads form a third block; and
a fourth subset of the first set of conductive pads, a fourth subset of the second set of conductive pads, and a fourth subset set of the third set of conductive pads form a fourth block, wherein the first, second, third, and fourth blocks form block rows and block columns.

17. The touch screen display of claim 16 further comprises:
the first subset of the first set of conductive pads includes four first conductive pads;
the first subset of the second set of conductive pads includes four second conductive pads; and
the first subset of the third set of conductive pads includes one third conductive pad, wherein the first block has a substantially square shape, wherein the four first conductors are positioned at corners of the substantially square shape, wherein the four second conductors are positioned in a cross pattern of the substantially square shape, and the one third conductive pad is positioned at a center of the substantially square shape.

18. The touch screen display of claim 17 further comprises:
the second subset of the first set of conductive pads includes another four first conductive pads;
the second subset of the second set of conductive pads includes another four second conductive pads; and
the second subset of the third set of conductive pads includes another one third conductive pad, wherein the second block has the substantially square shape, wherein the another four first conductors are positioned at corners of the substantially square shape, wherein the another four second conductors are positioned in a cross pattern of the substantially square shape, and the another one third conductive pad is positioned at a center of the substantially square shape.

19. The touch screen display of claim 17 further comprises:
the second subset of the first set of conductive pads includes another four first conductive pads;
the second subset of the second set of conductive pads includes another four second conductive pads; and
the second subset of the third set of conductive pads includes another one third conductive pad, wherein the second block has the substantially square shape, wherein the another four second conductors are positioned at corners of the substantially square shape, wherein the another four first conductors are positioned in a cross pattern of the substantially square shape, and the another one third conductive pad is positioned at a center of the substantially square shape.

20. The touch screen display of claim 11 further comprises:
the third set of conductive pads is coupled to form a second plurality of rows and a second plurality of columns as the plurality of zones, wherein the first orientation is along a 0 degree axis, wherein the second orientation is along a 90 degree axis, and wherein the third orientation includes a 45 degree axis for the second plurality of rows and a 135 degree axis for the second plurality of columns.
